(19) United States
(12) Patent Application Publication
(10) Pub. No.: US 2026/0313465 A1
(43) Pub. Date: Oct. 8, 2026

(54) Systems, Frameworks, and Methods for Conflict Detection and Mitigation in a Communication Network

(71) Applicant: Rakuten Symphony, Inc., Tokyo (JP)

(72) Inventors: Sridhar Bhaskaran, Bangalore, Karnataka (IN); Kexuan Sun, Weybridge, Surrey (GB)

(21) Appl. No.: 18/712,182

(22) PCT Filed: May 2, 2024
(86) PCT No.: PCT/US2024/027451

§ 371 Date: May 21, 2024

(30) Foreign Application Priority Data
Dec. 29, 2023 (IN) 202311089960
Mar. 21, 2024 (IN) 202311089960

(51) Int. Cl. H04W 28/18; H04W 24/08

(52) U.S. Cl. CPC H04W 28/18; H04W 24/08

(57) ABSTRACT

Disclosed herein is an apparatus associated with a network controller in an Open-Radio Access Network (O-RAN). The apparatus is configured to receive a request from a RAN function application from among a plurality of RAN function applications associated with the network controller. The request is indicative of a change in one or more parameters associated with the RAN function applications. The apparatus is configured to determine, based on a parameter dependency model, whether a conflict will occur as a result of the change in the one or more parameters. The parameter dependency model defines dependencies among a plurality of parameters associated with the plurality of RAN function applications. The apparatus is further configured to trigger, based on a set of mitigation rules, one or more reconciliation actions upon a determination that the conflict will occur as a result of the change in the one or more parameters.

### CROSS REFERENCE TO RELATED APPLICATION

This application claims the benefit of Indian Patent Application No. 202311089960, filed on Mar. 21, 2024, which claims the benefit of Indian Provisional Patent Application No. 202311089960, filed on Dec. 29, 2023, both of which are hereby incorporated by reference in their entirety.

### TECHNICAL FIELD

The present disclosure relates to conflict detection and mitigation in a communication network.

### BACKGROUND

As is widely known, a Radio Access Network (RAN) Intelligent Controller (RIC) is a component of an Open Radio Access Network (O-RAN) architecture which is responsible for controlling and optimizing RAN functions. The O-RAN Alliance, which is a global community of mobile network operators, vendors, and research and academic institutions focused on open RAN standards and interoperability, has defined a set of use cases and applications that the RIC supports. The RIC is divided into non-real-time and near-real-time components. The Non-Real Time RAN Intelligent Controller (Non-RT-RIC) is an element of operator's centralized Service Management and Orchestration (SMO) Framework, as defined by the O-RAN Alliance. On the other hand, the near-RT RIC resides within a telco edge or regional cloud and generally enables network optimization actions that take between ten milliseconds to one second to complete.

FIG. 1 illustrates a general O-RAN architecture 100 associated with RICs (near-RT RIC and non-RT RIC). The non-RT RIC acts as a control point of a non-real-time control loop and operates on a timescale greater than 1 second within the SMO framework. The functionalities of the non-RT RIC may be implemented through applications called rApps. The non-RT RIC may be connected to a near-RT RIC over an A1 interface. The near-RT RIC operates on a timescale between 10 milliseconds and 1 second. The functionalities of the near-RT RIC may be implemented through applications called xApps.

The near-RT RIC may further be connected to E2 nodes (for instance, O-RAN Centralized Unit (O-CU) and O-RAN Distributed Unit (O-DU)) over an E2 interface. The SMO framework may manage and orchestrate various RAN elements. For instance, the SMO may orchestrate an O-RAN Cloud (O-Cloud). The O-Cloud may refer to a collection of physical RAN nodes that host the RICs, O-CUs, O-DUs, etc. along with the supporting environments and components.

The near-RT-RIC and the non-RT RIC may employ various applications for achieving time-critical optimization objectives. The applications may modify various parameters leading to directly or indirectly affecting the performance of other applications. This leads to a conflict.

Regarding near-RT RIC, the conflicts may be direct conflicts, indirect conflicts, and implicit conflicts. Direct conflicts can be observed directly by conflict mitigation. Indirect conflicts can be observed based on dependence among the parameters and resources associated with the applications (xApps in case of near-RT RIC). Implicit conflicts may be difficult to observe directly and dependence among various xApps is not obvious. One example of direct conflicts may include two or more xApps requesting different settings for a same configuration of one or more parameters of a control target. Another example of direct conflicts may include a new request from an xApp that conflicts with a running configuration resulting from a previous request of another xApp or the same xApp. One example of indirect conflicts may include different xApps targeting different configuration parameters to optimize a same metric according to the respective objectives, which may lead to inadvertent network impact. One example of implicit conflicts may include different xApps optimizing different metrics and (re-)configuring different parameters, where optimizing a metric may have implicit and unwanted effect on metrics optimized by another xApp.

Regarding the non-RT RIC, conflicts may occur when applications (rApps) provide conflicting A1 policies or conflicting O1 and O2 related configurations. Conventional application logics for conflict mitigation are complex and hard-coded. Conventional techniques lack a comprehensive framework for conflict detection and mitigation. For instance, direct conflicts are handled by the applications while in case of indirect conflicts, conflict resolution is achieved by an operator rolling back the actions. Further, there exists no defined conflict resolution framework for implicit conflicts.

However, as described above, conventional techniques lack a comprehensive framework for conflict detection and mitigation. Thus, it is desired to address the above-mentioned disadvantages or other shortcomings or at least provide a useful alternative to overcome the above-mentioned disadvantages.

### SUMMARY

This summary is provided to introduce a selection of concepts, in a simplified format, that are further described in the detailed description of the disclosure. This summary is neither intended to identify key or essential inventive concepts of the invention nor is it intended to determine the scope of the disclosure.

Disclosed herein is an apparatus associated with a network controller in an Open-Radio Access Network (O-RAN). The apparatus is configured to receive a request from a RAN function application from among a plurality of RAN function applications associated with the network controller. The request is indicative of a change in one or more parameters associated with the plurality of RAN function applications. The apparatus is further configured to determine, based on a parameter dependency model associated with the apparatus, whether a conflict will occur as a result of the change in the one or more parameters. The parameter dependency model defines dependencies among a plurality of parameters associated with the plurality of RAN function applications. The apparatus is further configured to trigger, based on a set of mitigation rules associated with the parameter dependency model, one or more reconciliation actions upon a determination that the conflict will occur as a result of the change in the one or more parameters.

Disclosed herein is a method that comprises receiving a request from a RAN function application from among a plurality of RAN function applications associated with a network controlled in an Open-Radio Access Network (O-RAN). The request is indicative of a change in one or more parameters associated with the plurality of RAN function applications. Further, the method comprises determining, based on a parameter dependency model, whether a conflict will occur as a result of the change in the one or more parameters. The parameter dependency model defines dependencies among a plurality of parameters associated with the plurality of RAN function applications. Further, the method comprises triggering, based on a set of mitigation rules associated with the parameter dependency model, one or more reconciliation actions upon a determination that the conflict will occur as a result of the change in the one or more parameters.

The disclosed apparatus and method allow solving direct and indirect conflicts using a parameter dependency model and set of mitigation rules which are integrated with the network controllers, i.e., the near-RT RIC and the non-RT RIC, thereby providing a flexible configuration for conflict detection and mitigation.

To further clarify the advantages and features of the present disclosure, a more particular description of the disclosure will be rendered by reference to specific embodiments thereof, which is illustrated in the appended drawing. It is appreciated that these drawings depict only typical embodiments of the disclosure and are therefore not to be considered limiting its scope. The disclosure will be described and explained with additional specificity and detail with the accompanying drawings.

### BRIEF DESCRIPTION OF FIGURES

Features, aspects, and advantages of certain exemplary embodiments of the disclosure will be described below with reference to the accompanying drawings, in which like reference numerals denote like elements, and wherein:

FIG. 1 illustrates a general O-RAN architecture associated with RICs (near-RT RIC and non-R RIC) in a communication network, in accordance with existing arts;

FIG. 2 illustrates a block diagram for a network controller, in accordance with an embodiment of the present disclosure;

FIG. 3 illustrates a block diagram of the network controller when the network controller is a near-RT RIC, in accordance with an embodiment of the present disclosure;

FIGS. 4A-4B illustrate a detailed process flow employed by the near-RT RIC to use a parameter dependency model and a set of mitigation rules for conflict detection and mitigation, in accordance with an embodiment of the present disclosure;

FIGS. 5A-5B illustrate call flow interactions among xApps and the near RT-RIC for loading the parameter dependency model and the set of mitigation rules, in accordance with an embodiment of the present disclosure;

FIGS. 5C-5D illustrate the call flow interactions among the xApps and an apparatus for at least one of E2 subscription request and E2 control request, in accordance with an embodiment of the present disclosure;

FIGS. 5E-5F illustrate the call flow interactions among the xApps and the apparatus for E2 guidance request, in accordance with an embodiment of the present disclosure;

FIG. 6 illustrates a block diagram of the network controller when the network controller is the near-RT RIC, in accordance with another embodiment of the present disclosure;

FIGS. 7A-7B illustrate call flow interactions among the xApps, a platform layer apparatus, and a CDMF xApp for E2 subscription and control requests, in accordance with an embodiment of the present disclosure;

FIGS. 7C-7D illustrate the process flow among the xApps, the platform layer apparatus, and the CDMF xApp for E2 guidance requests, in accordance with an embodiment of the present disclosure;

FIG. 8 illustrates a block diagram of the network controller when the network controller is the non-RT RIC, in accordance with an embodiment of the present disclosure;

FIGS. 9A-9B illustrate a detailed process flow employed by the non-RT RIC to use the parameter dependency model and the set of mitigation rules for conflict detection and mitigation for A1 parameters, in accordance with an embodiment of the present disclosure;

FIGS. 9C-9D illustrate a detailed process flow employed by the non-RT RIC to use the parameter dependency model and the set of mitigation rules for conflict detection and mitigation for O1 and O2 parameters, in accordance with an embodiment of the present disclosure;

FIG. 10 illustrates a block diagram of the network controller when the network controller is the non-RT RIC, in accordance with another embodiment of the present disclosure;

FIG. 11 illustrates a framework for reconciliation, in accordance with an embodiment of the present disclosure; and FIGS. 12A-12C illustrate process flows depicting a method for conflict detection and mitigation, in accordance with an embodiment of the present disclosure.

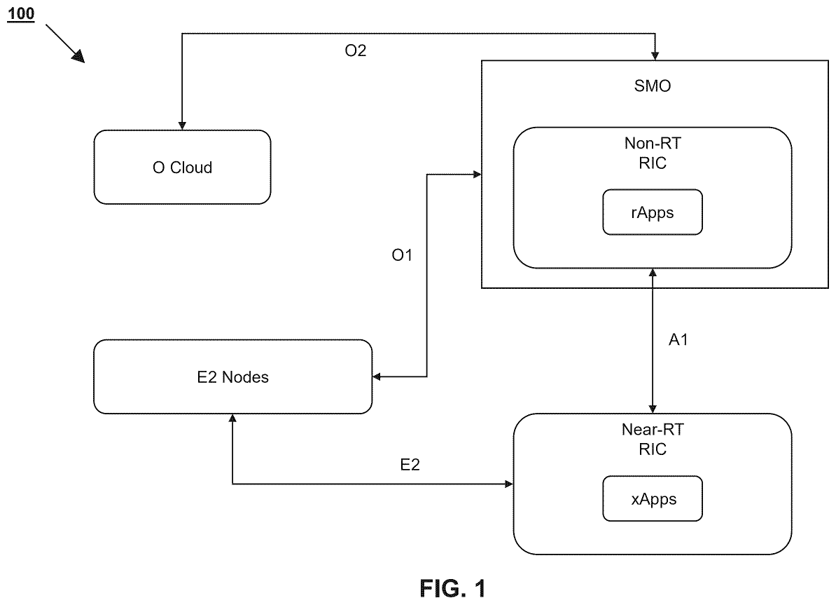

### DETAILED DESCRIPTION

The following detailed description of example embodiments refers to the accompanying drawings. The foregoing disclosure provides illustration and description, but is not intended to be exhaustive or to limit the implementations to the precise form disclosed. Modifications and variations are possible in light of the above disclosure or may be acquired from practice of the implementations. Further, one or more features or components of one embodiment may be incorporated into or combined with another embodiment (or one or more features of another embodiment). Additionally, in the flowcharts and descriptions of operations provided below, it is understood that one or more operations may be omitted, one or more operations may be added, one or more operations may be performed simultaneously (at least in part), and the order of one or more operations may be switched, as long as these modifications may not affect the resulting scope of the invention.

It will be apparent that systems and/or methods, described herein, may be implemented in different forms of hardware, software, or a combination of hardware and software. The actual specialized control hardware or software code used to implement these systems and/or methods is not limiting of the implementations. Thus, the operation and behavior of the systems and/or methods were described herein without reference to specific software code. It is understood that software and hardware may be designed to implement the systems and/or methods based on the description herein.

Even though particular combinations of features are recited in the claims and/or disclosed in the specification, these combinations are not intended to limit the disclosure of possible implementations. In fact, many of these features may be combined in ways not specifically recited in the claims and/or disclosed in the specification. Although each dependent claim listed below may directly depend on only one claim, the disclosure of possible implementations includes each dependent claim in combination with every other claim in the claim set.

No element, act, or instruction used herein should be construed as critical or essential unless explicitly described as such. Also, as used herein, the articles “a” and “an” are intended to include one or more items, and may be used interchangeably with “one or more.” Where only one item is intended, the term “one” or similar language is used. Also, as used herein, the terms “has,” “have,” “having,” “include,” “including,” or the like are intended to be open-ended terms. Further, the phrase “based on” is intended to mean “based, at least in part, on” unless explicitly stated otherwise. Furthermore, expressions such as “at least one of [A] and [B]”, “[A] and/or [B]”, or “at least one of [A] or [B]” are to be understood as including only A, only B, or both A and B.

The foregoing disclosure provides illustration and description but is not intended to be exhaustive or to limit the implementations to the precise form disclosed. Modifications and variations are possible in light of the above disclosure or may be acquired from the practice of the implementations.

Now embodiments of the present disclosure will be described below in detail with reference to the accompanying drawings.

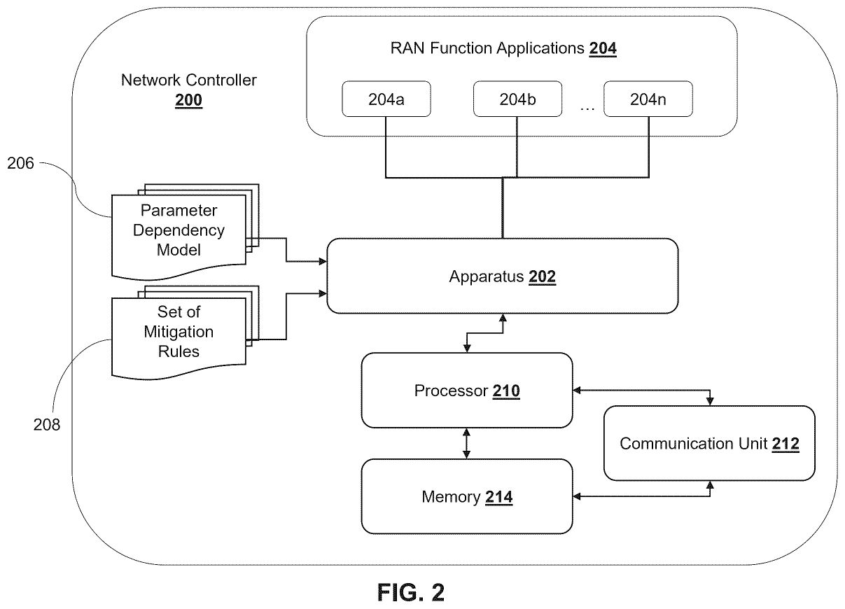

FIG. 2 illustrates a block diagram for a network controller 200, in accordance with an embodiment of the present disclosure. The network controller 200 may be associated with a Radio Access Network (RAN) or an Open-RAN (O-RAN). The RAN may facilitate communication between a user equipment (UE) and a core network. The RAN may be associated with cellular networks such as 4G Long-Term Evolution (LTE) and 5G. The network controller 200 may be configured to manage services within the RAN. The terms “network controller” and “network management entity” may be used interchangeably in the present disclosure. In an embodiment, the network controller 200 may be configured to manage resource allocation and optimization in the network for one or more UEs. In an embodiment, the network controller 200 may be configured to facilitate the orchestration and optimization of radio resources, enabling features such as dynamic spectrum sharing, network slicing, and allocation of resources. The network controller 200 may be in communication with various other network entities, such as, gNodeB (gNB), Central Unit (CU), and Distributed Unit (DU).

In an embodiment, the network controller 200 may be RAN Intelligent Controllers (RICs). In an embodiment, the RICs may include a near-real time RIC (near-RT RIC) and a non-real time RIC (non-RT RIC). The RICs may be configured to make decisions on radio resources, such as optimizing the use of spectrum, adjusting parameters, adapting to network conditions, etc. The network controller 200 may further be associated with a Service Management and Orchestration (SMO) unit. The SMO may be configured to manage end-to-end services across the network, such as, service installation, resource allocation, service orchestration, etc.

In some embodiments, the network controller 200 may be implemented in the form of virtualized software units in hardware or cloud environments. In some embodiments, the network controller may be implemented as dedicated hardware units.

The network controller 200 may include an apparatus 202 for parameter conflict detection and request handling in a communication network associated with the network controller 200. The apparatus 202 may be configured to solve direct and indirect conflicts. The apparatus 202 may alternatively be referred to as a Conflict Detection and Mitigation (CDMF) unit. The network controller 200 may include a plurality of RAN function applications 204a-204n (collectively referred to as 204). The apparatus 202 may be in communication with the plurality of RAN function applications 204.

The network controller 200 may further be associated with a parameter dependency model 206 and a set of mitigation rules 208. The parameter dependency model 206 and the set of mitigation rules 208 may be utilized to detect conflicts and trigger reconciliation actions. In an embodiment, the parameter dependency model 206 and the set of mitigation rules 208 may be pre-defined.

The network controller 200 may include one or more processor(s) 210 (also, referred to as processor 210), a communication unit 212 (e.g., communicator or communication interface), and a storage unit (e.g., memory 214). The communication unit 212 may perform functions for transmitting and receiving signals. The processor 210 and the memory 214 may be communicably coupled to the apparatus 202. The memory 214 may include executable instructions that, when executed by the processor 210, cause the apparatus to perform the functions as described in the present disclosure. As an example, the processor 210 may be a single processing unit or a number of units, all of which could include multiple computing units. The processor 210 may be implemented as one or more microprocessors, microcomputers, microcontrollers, digital signal processors, central processing units, state machines, logic circuitries, and any devices that manipulate signals based on operational instructions. Among other capabilities, the processor 210 is configured to fetch and execute computer-readable instructions and data stored in the memory. The processor 210 may include one or a plurality of processors. At this time, one or a plurality of processors 210 may be a general-purpose processor, such as a central processing unit (CPU), an application processor (AP), or the like, and an AI-dedicated processor such as a neural processing unit (NPU). The processor 210 may control the processing of input data in accordance with a predefined operating rule or artificial intelligence (AI) model stored in the non-volatile memory and the volatile memory, i.e., the memory 214. The predefined operating rule or artificial intelligence model is provided through training or learning.

The memory 214 may include any non-transitory computer-readable medium known in the art including, for example, volatile memory, such as static random-access memory (SRAM) and dynamic random-access memory (DRAM), and non-volatile memory, such as read-only memory (ROM), erasable programmable ROM, flash memories, hard disks, optical disks, and magnetic tapes.

The apparatus 202, in conjunction with the processor 210, may be configured to receive a request from a RAN function application (for example, 204a) from among the plurality of RAN function applications 204. The request may be indicative of a change in one or more parameters associated with the plurality of RAN function applications 204. In an embodiment, the apparatus 202 may be in communication with the plurality of RAN function applications 204 via Application Programming Interfaces (APIs). In an embodiment, the request may be received over an R1 interface. In non-limiting examples, the request may include an E2 subscription request, an E2 control request, an E2 guidance request, etc.

The apparatus 202 in conjunction with the processor 210 may further be configured to determine whether a conflict will occur as a result of the change in the one or more parameters. The apparatus 202 may determine occurrence of a conflict based on the parameter dependency model 206. In an embodiment, the parameter dependency model 206 defines dependencies among a plurality of parameters associated with the plurality of RAN function applications 204. In an embodiment, the change in the one or more parameters may include change in an existing parameter or a subscription for a new parameter. In an embodiment, the apparatus 202 utilizes the parameter dependency model 206 and identifies whether the change in parameter causes conflicts with other parameters from among the plurality of parameters in the parameter dependency model 206. The terms “parameter dependency model” and “parameter dependency graph” may be used interchangeably in the present disclosure.

In an embodiment, the parameter dependency model 206 may be generated and linked to the apparatus 202 during network design by an operator. The operator may load the parameter dependency model 206 into the network controller 200 for use by the apparatus 202. In an embodiment, the parameter dependency model 206 may be generated by one or more of the plurality of RAN function applications 204 based on a generative Artificial Intelligence (AI) model. In an embodiment, the generative AI model may be stored in the memory 214 and accessed by the plurality of RAN function applications 204.

In an embodiment, the apparatus 202 in conjunction with the processor 210 may further be configured to identify the one or more parameters associated with the request received from the RAN function application 204a. The one or more parameters may be identified based on multiple factors depending on whether the network controller 200 is a near-RT RIC or a non-RT RIC. In non-limiting examples, the one or more parameters may be identified based on RAN function ID, E2 service models (E2SM) Object Identifier (OID), parameter path in a particular format, parameter value to set, O1 resource Uniform Resource Identifier (URI), A1 policy ID, etc.

Further, the apparatus 202 may be configured to determine whether the identified one or more parameters are present in the library of the parameter dependency model 206. In an embodiment, the parameter dependency model 206 may be stored in the memory 214.

Further, dependency of the one or more parameters with other parameters, such as Key Performance Indicators (KPIs), policy parameters, configuration parameters, and control parameters, may be identified. The apparatus 202 may be configured to determine whether the conflict will occur based on the dependency of the one or more parameters on the other parameters (one or more of the KPIs, the policy parameters, the configuration parameters, and the control parameters).

In an embodiment, the policy parameters, the configuration parameters, and the control parameters may be exposed as parameters through one or more open interfaces including, but not limited to, A1 interface, O1 interface, and E2 interface. The apparatus 202 may be configured to identify, based on the parameter dependency model 206, whether the identified one or more parameters have a dependency on one or more of the other parameters associated with at least one of the apparatus 202, the plurality of RAN function applications 204 running in the network controller 200, and controlled network functions. In an embodiment, the controlled network functions may include E2 nodes, such as, RAN Distributed Unit (DU), RAN Centralized Unit Control Plane (CU-CP), and RAN Centralized Unit User Plane (CU-UP).

Upon a determination that the conflict will occur as a result of the change in the one or more parameters, the apparatus 202 may be configured to trigger one or more reconciliation actions. The reconciliation actions may be triggered based on the set of mitigation rules 208. The set of mitigation rules 208 may be associated with the parameter dependency model 206 and may define reconciliation actions to be performed when a parameter conflict is encountered. The set of mitigation rules 208 may be utilized in the event of determination of the conflict. In case of a determination that the conflict will not occur as a result of the change in the one or more parameters, the apparatus 202 may be configured to accept the change in the one or more parameters.

In an embodiment, the set of mitigation rules 208 may be generated and linked to the apparatus 202 during network design by the operator. In an embodiment, the set of mitigation rules 208 may be generated by one or more of the plurality of RAN function applications 204 based on the generative AI model.

In an embodiment, the apparatus 202 may utilize the set of mitigation rules 208 in order to determine whether acceptance of the change in the one or more parameters is allowed or disallowed. In case the acceptance of the change in the one or more parameters is disallowed, the set of mitigation rules 208 may define an action of rejecting the change in the one or more parameters. In case the acceptance of the change in the one or more parameters is allowed, the set of mitigation rules 208 may define an action of accepting the change in the one or more parameters.

In non-limiting examples, the one or more reconciliation actions include stopping one or more of the plurality of RAN function applications 204, adjusting a configuration of one or more of the plurality of RAN function applications 204, and adjusting an operation of E2 nodes associated with the network controller 200.

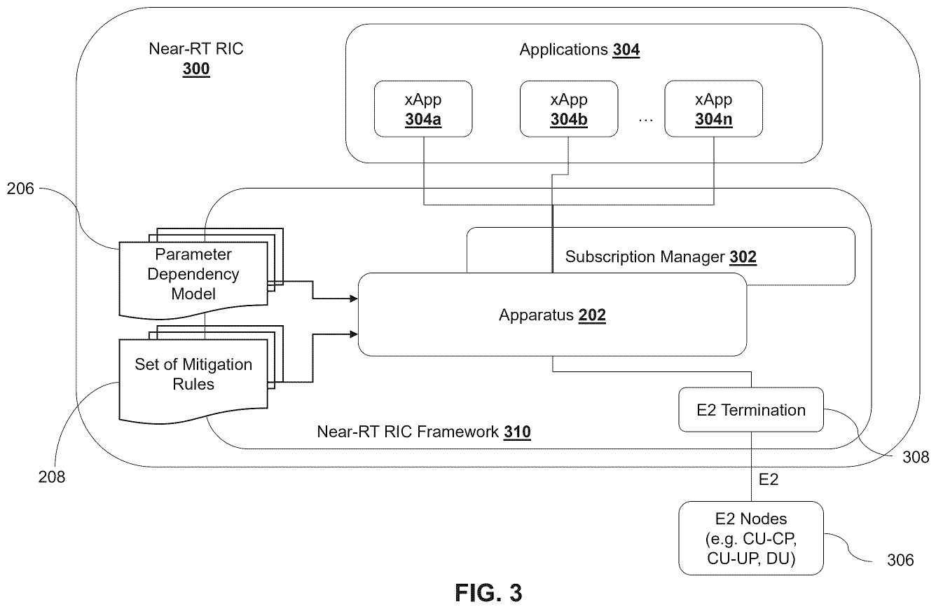

As described above, the network controller 200 may include a near-RT RIC and a non-RT RIC. FIG. 3 illustrates a block diagram of the network controller 200 when the network controller 200 is a near-RT RIC 300, in accordance with an embodiment of the present disclosure. The near-RT RIC 300 comprises the components as described above for the network controller 200 with reference to FIG. 2 and all of the components are not depicted for sake of brevity. The near-RT RIC 300 comprises the apparatus 202 for parameter conflict detection, mitigation, and request handling in the communication network in order to solve direct and indirect conflicts. The near-RT RIC 300 may additionally include a subscription manager 302. When the network controller 200 is the near-RT RIC 300, the plurality of RAN function applications 204 include a plurality of xApps 304a, 304b, . . . 304n (collectively referred to as ‘xApps 304’). The apparatus 202 may be in communication with the plurality of xApps 304 via multiple APIs. The near-RT RIC 300 may further be communicatively coupled with controlled network functions, i.e., E2 nodes 306. The E2 nodes 306 may include CU-CP, CU-UP, and DU. In an embodiment, the near-RT RIC 300 may be communicatively coupled with the E2 nodes 306 via an E2 termination unit 308. The subscription manager 302 may be configured to manage subscriptions from the xApps 304 to the E2 nodes 306. The subscription manager 302 may further be configured to merge identical subscriptions from various xApps 304 into a single subscription towards the E2 nodes 306.

In the illustrated embodiment, the apparatus 202 is included in the near-RT RIC 300 at a framework level, i.e., forming a part of a near-RT RIC framework 310. The apparatus 202 is associated with the parameter dependency model 206 and the set of mitigation rules 208. In an embodiment, the parameter dependency model 206 and the set of mitigation rules are pre-defined. In an embodiment, the parameter dependency model 206 and the set of mitigation rules 208 are generated and linked to the apparatus 202 during network design by an operator. That is, the operator may generate the parameter dependency model 206 and the set of mitigation rules 208 and load the parameter dependency model 206 and the set of mitigation rules 208 for use by the apparatus 202. In an embodiment, the parameter dependency model 206 and the set of mitigation rules 208 are generated by one or more of the xApps 304 based on a generative AI model. The generative AI model may be stored in the memory 214.

As described above, the parameter dependency model 206 may be utilized to detect conflicts. The parameter dependency model 206 defines dependencies among a plurality of parameters associated with the plurality of xApps 304. In an embodiment, the parameter dependency model 206 defines dependencies among E2 parameters and O1 parameters associated with the plurality of xApps 304.

In some embodiments, one or more of the plurality of xApps 304 may transmit a request to the apparatus 202. For instance, the apparatus 202 may receive a request from the xApp 304a indicating a change in one or more parameters associated with the near-RT RIC 300. In non-limiting examples, the request may include an E2 subscription request, an E2 control request, an E2 guidance request, etc. Upon receiving the request from the xApp 304a, the apparatus 202 may refer to the parameter dependency model 206 for detecting conflicts which may occur as a result of the change in the one or more parameters. In an embodiment, the apparatus 202 may refer to past parameters subscribed or set via previous control requests. In an embodiment, the apparatus 202 may identify the one or more parameters and determine whether the identified one or more parameters have a dependency on KPIs, policy parameters, configuration parameters, and control parameters.

In case the apparatus 202 determines that a conflict may occur, one or more reconciliation actions may be triggered based on the set of mitigation rules 208. In an embodiment, when the conflict is detected, the request may be rejected. In another embodiment, in case of no detected conflicts, a success indication may be sent to the xApp 304a and the received request may be logged in the memory 214 for comparison against future requests.

In non-limiting examples, the reconciliation actions may include stopping the plurality of xApps 304, adjusting a configuration of the xApps 304 (with a list of parameters and values fed in), stopping xApps 304 in the reverse order of onboarding until KPI rebounds, changing baseline O1 configuration of E2 nodes 306 (with a list of parameters and values fed in), rollback logged sequence of E2 actions at the E2 nodes 306 one at a time until next rollback trigger from SMO (the E2 nodes support logging the operations performed via E2 and O1 interfaces in a time sequenced manner), and rollback logged sequence of E2 actions at the E2 nodes 306 “N” at a time until next rollback trigger from SMO (the E2 nodes support logging the operations performed via E2 and O1 interfaces in a time sequenced manner).

In an embodiment, the apparatus 202 may be configured to determine that an acceptance of the change in the one or more parameters is allowed based on the set of mitigation rules 208. Further, the apparatus 202 may determine a requirement of change in a related parameter associated with at least one other xApp, for example, xApp 304b. The apparatus 202 may then send a related parameter request to the xApp 304b indicating a request to accept the change in the related parameter.

In an embodiment, the xApp 304b may accept the change in the related parameter. In such a scenario, the apparatus 202 may receive a related parameter accept response from the xApp 304b indicating that the change in the related parameter is accepted. Upon receiving the related parameter accept response, the apparatus 202 accepts the change in the one or more parameters in the request sent by the xApp 304a. The xApp 304a may then send the request to the E2 nodes 306 upon receiving the success indication from the apparatus 202.

In an embodiment, the xApp 304b may reject the change in the related parameter. In such a scenario, the apparatus 202 may receive a related parameter reject response from the xApp 304b indicating that the change in the related parameter is rejected. Upon receiving the related parameter reject response, the apparatus 202 rejects the change in the one or more parameters in the request sent by the xApp 304a.

Thus, all subscriptions for parameter change events as well as requests for changing parameters pass through the apparatus 202 for conflict detection and mitigation. The apparatus as described with respect to the embodiment of FIG. 3 allows conflict detection and mitigation at a platform level. In such an embodiment, focus need not be on conflict resolutions, rather, the focus can be on preparing the logic behind the applications that can act as per the requests and commands from the platform.

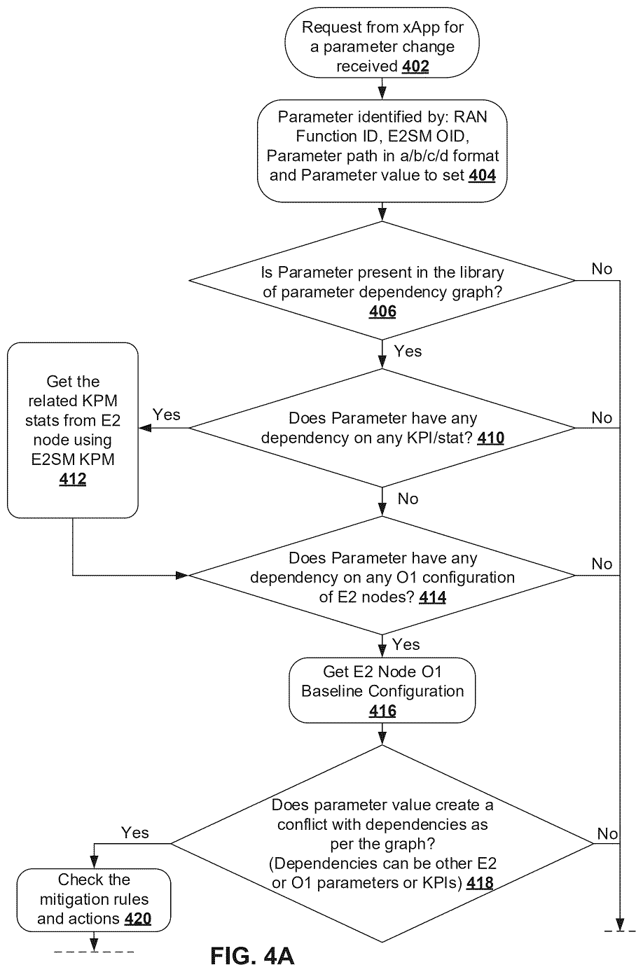

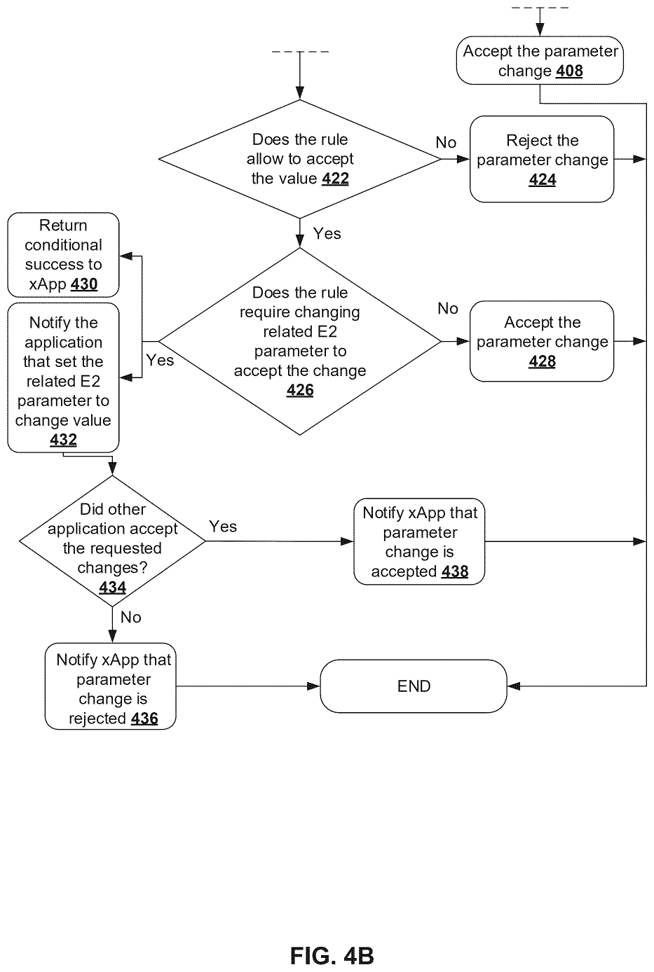

FIGS. 4A-4B illustrate a detailed process flow employed by the near-RT RIC 300 to use the parameter dependency model 206 and the set of mitigation rules 208 for conflict detection and mitigation. Initially, at step 402, a request for a parameter change may be received by the apparatus 202 from the xApp 304a. At step 404, the one or more parameters may be identified based on RAN function ID, E2 service models (E2SM) Object Identifier (OID), parameter path in a particular format, parameter value to set, etc.

At step 406, it is determined whether the parameter is present in the library of the parameter dependency model 206. If the parameter is not present in the parameter dependency model 206, the parameter change is accepted at step 408 and the process ends. If the parameter is present in the parameter dependency model 206, it is determined whether the parameter has any dependency on any KPI at step 410. In case of no dependency, the process moves to step 414. In case of dependency on any KPI, at step 412, the related Key Performance Measurement (KPM) stats may be obtained from the associated E2 nodes 306 using E2SM KPM and the process moves to step 414.

At step 414, it is determined whether the parameter has any dependency on any O1 configuration of the associated E2 nodes 306. In case of no dependency, the parameter change is accepted at step 408 and the process ends. In case of dependency, the E2 node O1 baseline configuration is obtained at step 416. At step 418, it is determined whether the parameter value creates a conflict with dependencies based on the parameter dependency model 206. In an embodiment, the dependencies may include E2 parameters, O1 parameters, or KPIs. In case of no conflicts, the parameter change is accepted at step 408.

In case of conflicts, the set of mitigation rules 208 are checked at step 420. If the rules do not allow acceptance of value at step 422, then, at step 424, the parameter change is rejected. If the set of mitigation rules 208 allows acceptance of value, then, at step 426, it is determined whether the set of mitigation rules 208 require changing related E2 parameters to accept the change. If no change is required, then, at step 428, the parameter change is accepted. If change is required, then, at step 430, a conditional success indication is sent to the xApp 304a, and at step 432, the xApp (for instance, xApp 304b) that has set the related E2 parameter is notified to change value. At step 434, it is determined whether the other application, i.e., xApp 304b has accepted the requested change. In case other xApp 304b has not accepted the requested change, then, at step 436, the xApp 304a is notified that the parameter change is rejected. In case the xApp 304b accepts the requested change, then, at step 438, the xApp 304a is notified that the parameter change is accepted. The process then ends.

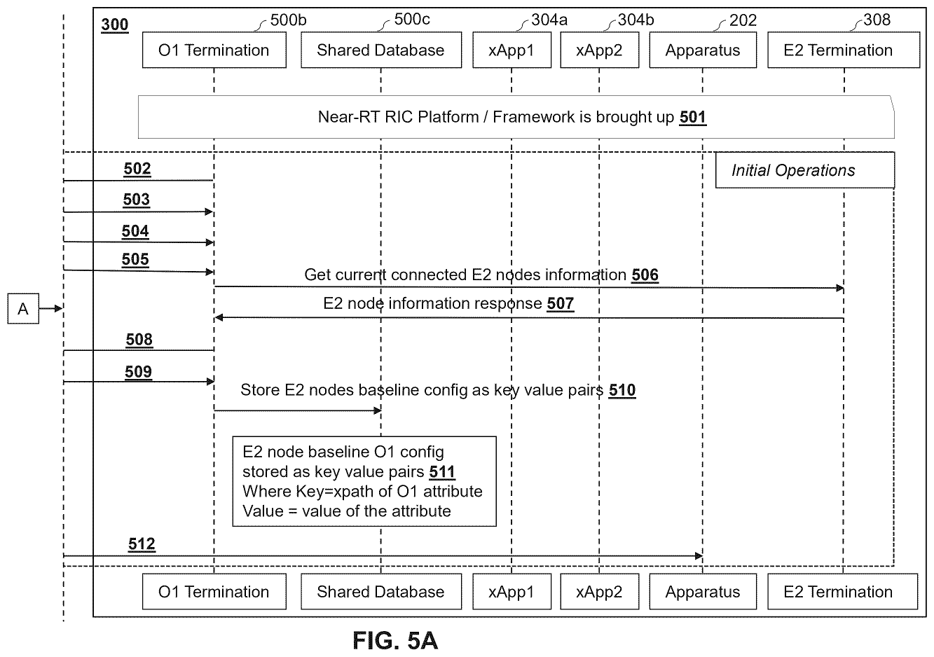

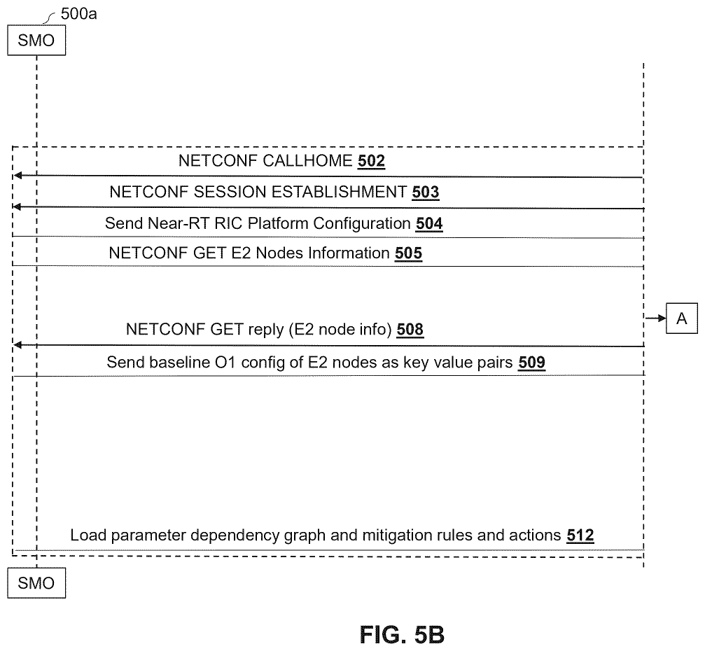

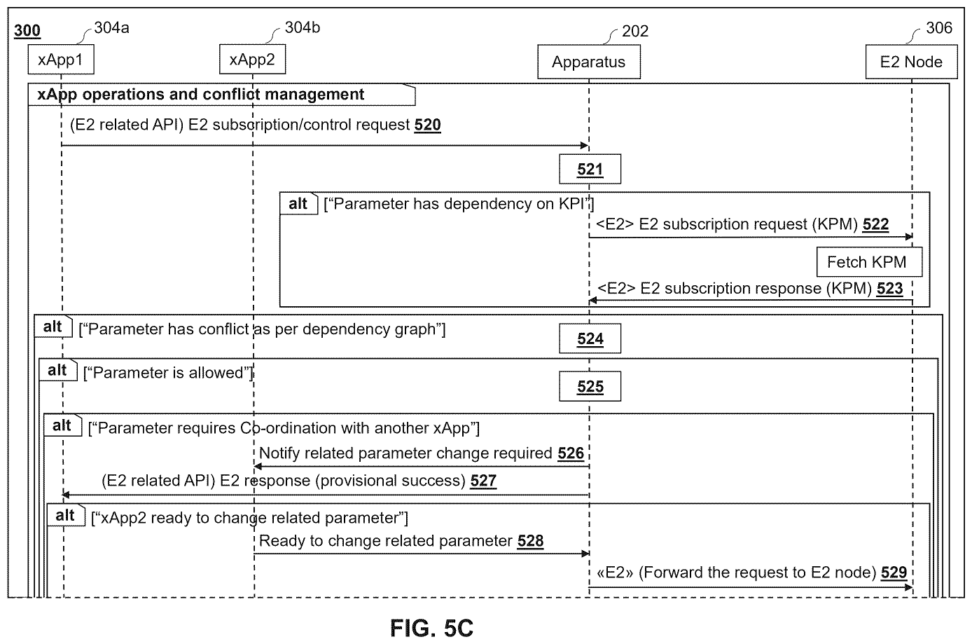

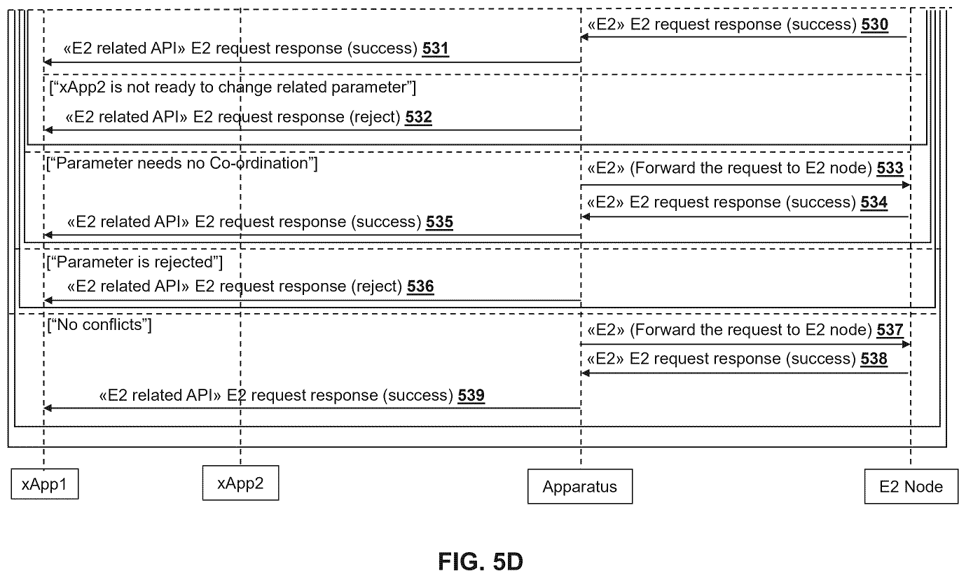

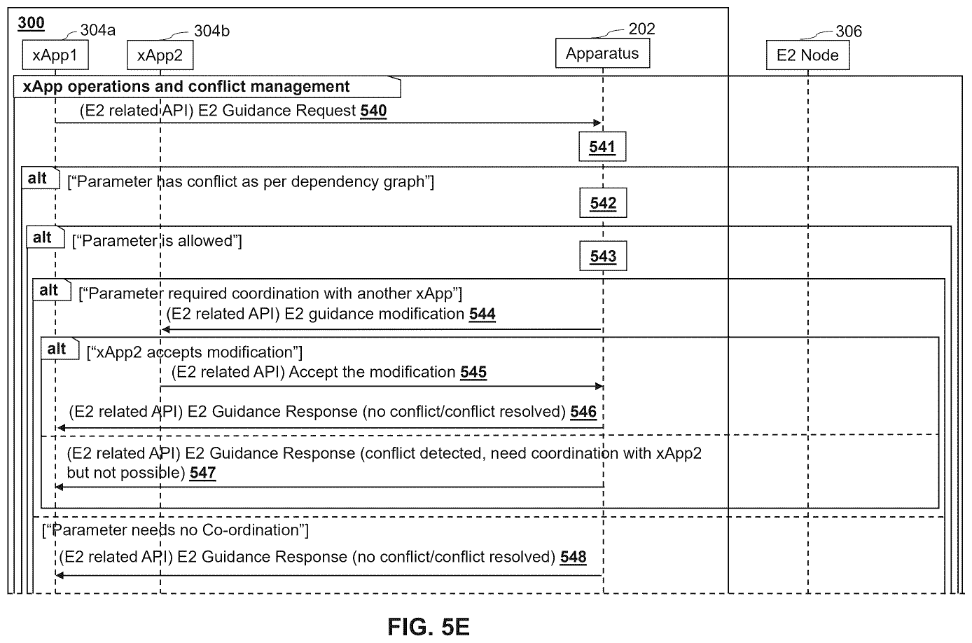

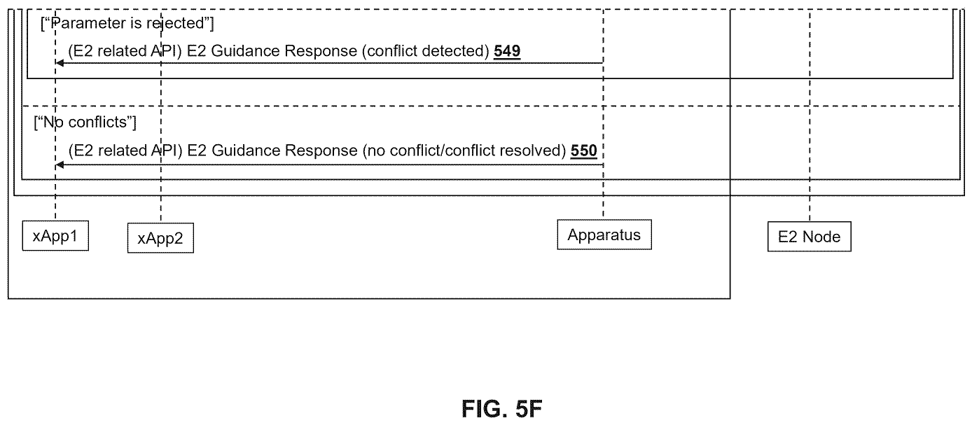

Referring to FIGS. 5A-5F, call flow interactions among the plurality of xApps 304 and the near-RT RIC 300 or the apparatus 202 are illustrated, in accordance with various embodiments of the present disclosure. FIGS. 5A-5B illustrate the process flow among the xApps 304a-304b and the near RT-RIC 300 for loading the parameter dependency model 206 and the set of mitigation rules 208 to the apparatus 202. The near RT-RIC 300 may be in communication with a Service Management & Orchestrator (SMO) 500a. The near RT-RIC 300 may include components, such as O1 termination unit 500b, shared database 500c, the xApp 304a, the xApp 304b, the apparatus 202, and the E2 termination unit 308.

At step 501, the near-RT RIC framework is brought up. At step 502, the O1 termination unit 500b sends a NETCONF CALLHOME message to the SMO 500a. At step 503, a NETCONF SESSION ESTABLISHMENT message is exchanged between the O1 termination unit 500b and the SMO 500a. At step 504, the SMO 500a sends the near-RT RIC platform configuration to the O1 termination unit 500b. At step 505, the SMO 500a sends the NETCONF GET E2 Nodes information to the O1 termination unit 500b.

At step 506, the O1 termination unit 500b requests for information of currently connected E2 nodes 306 (shown in FIG. 3) from the E2 termination unit 308. At step 507, the E2 termination unit 308 sends the E2 node information response to the O1 termination unit 500b. At step 508, the O1 termination unit 500b sends NETCONF GET reply to the SMO 500a having the E2 node information. At step 509, the SMO 500a sends the baseline O1 configuration of E2 nodes 306 to the O1 termination unit 500b as key value pairs.

At step 510, the O1 termination unit 500b sends the received information for E2 nodes baseline configuration to be stored in the shared database 500c. At step 511, the E2 node baseline configuration is stored as key value pairs where Key is the xpath of O1 attribute and Value is the value of the attribute. At step 512, the SMO 500a loads the parameter dependency model 206 and the set of mitigation rules 208 to the apparatus 202.

FIGS. 5C-5D illustrate the process flow among the xApps 304a-304b and the apparatus 202 for at least one of E2 subscription request and E2 control request. The near RT-RIC 300 may be in communication with the E2 node 306 and may include components such as xApp 304a, xApp 304b, and the apparatus 202.

At step 520, the xApp 304a sends an E2 subscription request or E2 control request indicating change of the parameter to the apparatus 202.

At step 521, the apparatus 202 checks the parameter dependency model 206. For instance, the apparatus 202 may determine that the parameter has a dependency on KPI and the apparatus 202 fetches KPM from the E2 node 306 by sending an E2 subscription request (KPM) at step 522 and receiving an E2 subscription response (KPM) at step 523.

In case the parameter has conflict as per the parameter dependency model 206, the apparatus 202 checks if the set of mitigation rules 208 allow acceptance of the parameter, as shown by step 524.

In case the parameter is allowed, the CDMF checks whether the parameter requires changing a related parameter in xApp 304b, as shown by step 525.

In case the parameter requires coordination with the xApp 304b, at step 526, the apparatus 202 notifies the xApp 304b about the related parameter change required and sends a E2 subscription response or E2 control response to the xApp 304a indicating provisional success at step 527.

In case the xApp 304b is ready to change the related parameter, at step 528, the xApp 304b sends a ready to change related parameter response (related parameter accept response) to the apparatus 202. At steps 529-530, the apparatus 202 forwards the request to the E2 node 306 and receives a success response from the E2 node 306. At step 531, the apparatus 202 sends the success response to the xApp 304a.

In case the xApp 304b is not ready to change the related parameter, the apparatus sends a reject response to the xApp 304a, as shown at step 532.

In case no co-ordination for the parameter is required, the apparatus 202 forwards the E2 subscription/control request to the E2 node 306, receives a success response from the E2 node 306, and sends the success response to the xApp 304a, as shown by steps 533-535.

In case the parameter is rejected, then a reject response is sent to the xApp 304a, as shown by step 536.

In case there was no conflict for the parameter, the apparatus 202 forwards the E2 subscription/control request to the E2 node 306, receives a success response from the E2 node 306, and sends the success response to the xApp 304a, as shown by steps 537-539.

In some embodiments, the xApps 304 may send an E2 guidance request to the near-RT RIC 300 prior to sending the E2 subscription request or the E2 control request. If the parameter change has conflict and needs coordination with another xApp (xApp 304b), an E2 Guidance request can be sent from the near-RT RIC 300 to the xApp 304b in order to coordinate the parameter changes. In some embodiments, the parameter dependency model 206 may be automatically generated by the plurality of xApps 304 based on the generative AI model where the input or prompt for the generative AI model is a set of intent and goals.

FIGS. 55E-5F illustrate the process flow among the xApps 304a-304b and the apparatus 202 for E2 guidance request. The near RT-RIC 300 may be in communication with the E2 node 306 and may include components such as the xApp 304a, the xApp 304b, and the apparatus 202.

At step 540, the xApp 304a may send an E2 guidance request to the apparatus 202. At step 541, the apparatus 202 may check the parameter dependency model 206 for conflicts.

In case the parameter has conflict as per the parameter dependency model 206, at step 542, the apparatus 202 checks whether the set of mitigation rules 208 allow acceptance of the parameter.

In case the parameter is allowed, at step 543, the apparatus 202 checks, using a related parameter request, whether the parameter requires changing related parameter in another xApp, i.e., the xApp 304b.

In case the parameter requires coordination with xApp 304b, then, at step 544, the apparatus 202 sends an E2 guidance (modification) message to the xApp 304b.

In case the xApp 304b accepts the modification, at step 545, the xApp 304b sends an acceptance message (related parameter accept response) to the apparatus 202. Further, at step 546, the apparatus 202 sends an E2 guidance response to the xApp 304a indicating no conflict or conflict resolved.

In case the xApp 304b does not accept the modification, at step 547, the apparatus 202 sends an E2 guidance response to the xApp 304b indicating that conflict is detected, and coordination with the xApp 304b is needed but is not possible.

Further, in case the parameter does not require coordination (as a result of step 542), then the apparatus 202 sends an E2 guidance response to the xApp 304a indicating no conflict or conflict resolved, as shown by step 548.

Further, in case the parameter is rejected (as a result of step 543), then the apparatus 202 sends an E2 guidance response to the xApp 304a indicating conflict detected, as shown by step 549.

Further, in case the parameter has no conflict (as a result of step 541), then the apparatus 202 sends an E2 guidance response to the xApp 304a indicating no conflict or conflict resolved, as shown by step 550.

In some embodiments, the parameter dependency model 206 and the set of mitigation rules 208 may be encoded in a machine-readable data format and loaded to the apparatus 202. In a non-limiting example, the machine-readable data format is a JavaScript Object Notation (JSON) document complying to a JSON schema. The JSON schema defines a grammar which enables defining the parameter dependencies and relationships along with actions to perform if those dependencies or relationships are not met (i.e., when conflicts arise) in a JSON document. For each parameter dependency rule defined in the parameter dependency model 206, an action to execute upon detecting a conflict as per the parameter dependency rule is provided. As a result, both direct and indirect conflicts can be addressed.

In non-limiting examples, the reconciliation actions may include stopping the xApp 304a, adjusting a configuration of the xApp 304a (with list of parameters and values fed in), stopping the plurality of xApps 304 in the reverse order of onboarding until KPI rebounds, changing baseline O1 configuration of E2 nodes 306 (with list of parameters and values fed in), rollback logged sequence of E2 actions at the E2 nodes 306 one at a time until next rollback trigger from SMO (it is expected that the E2 nodes support logging the operations performed via E2 and O1 interfaces in a time sequenced manner), and rollback logged sequence of E2 actions at the E2 node “N” at a time until next rollback trigger from SMO (it is expected that the E2 nodes support logging the operations performed via E2 and O1 interfaces in a time sequenced manner).

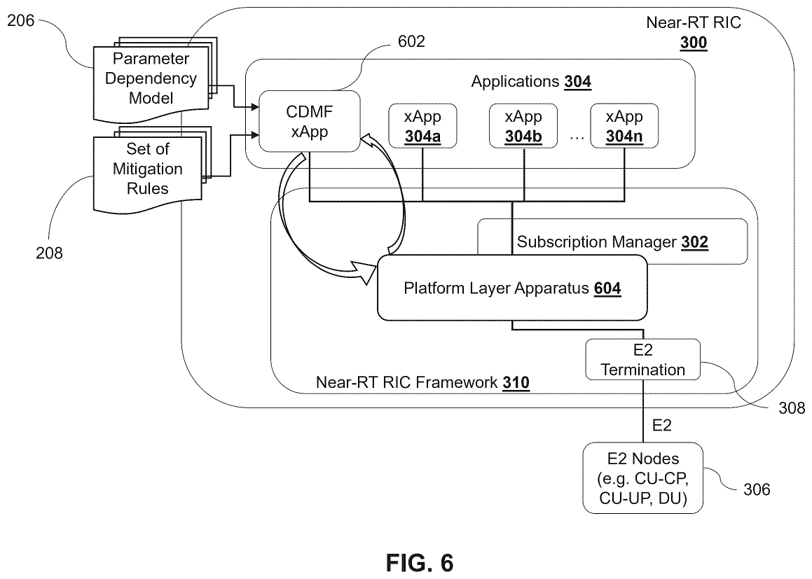

FIG. 6 illustrates another block diagram of the network controller 200 when the network controller 200 is the near-RT RIC 300, in accordance with another embodiment of the present disclosure. The near-RT RIC 300 comprises the components as described above for the network controller 200 with reference to FIG. 2. The near-RT RIC 300 comprises the apparatus 202 for parameter conflict detection, mitigation, and request handling in the communication network in order to solve direct and indirect conflicts. The near-RT RIC 300 may additionally include a subscription manager 302. The near-RT RIC 300 includes the plurality of xApps 304a, 304b, . . . 304n (collectively referred to as ‘xApps 304’). The near-RT RIC 300 may further be communicatively coupled with controlled network functions, i.e., E2 nodes 306 via the E2 termination unit 308.

The near-RT RIC 300 depicted in FIG. 6 may correspond to the near-RT RIC 300 illustrated in FIG. 3, however, in the illustrated embodiment of FIG. 6, the apparatus 202 (corresponding to apparatus 202 of FIG. 3) itself is implemented at an application level as a special xApp, as shown by block 602. The special xApp may be referred to as CDMF xApp 602 hereinafter. The functions of the apparatus 202 mentioned above may be implemented using the CDMF xApp 602. Further, the near-RT RIC 300 may include a framework level apparatus or a platform layer apparatus 604. The apparatus as described with respect to the embodiment of FIG. 6 enables loading various conflict mitigation logics in the form of an application. Changes at platform level may thus be avoided, allowing the platform to be free of complexities. Further, an operator may be enabled to choose an optimal conflict detection and mitigation application from multiple options based on the implementation required in different scenarios.

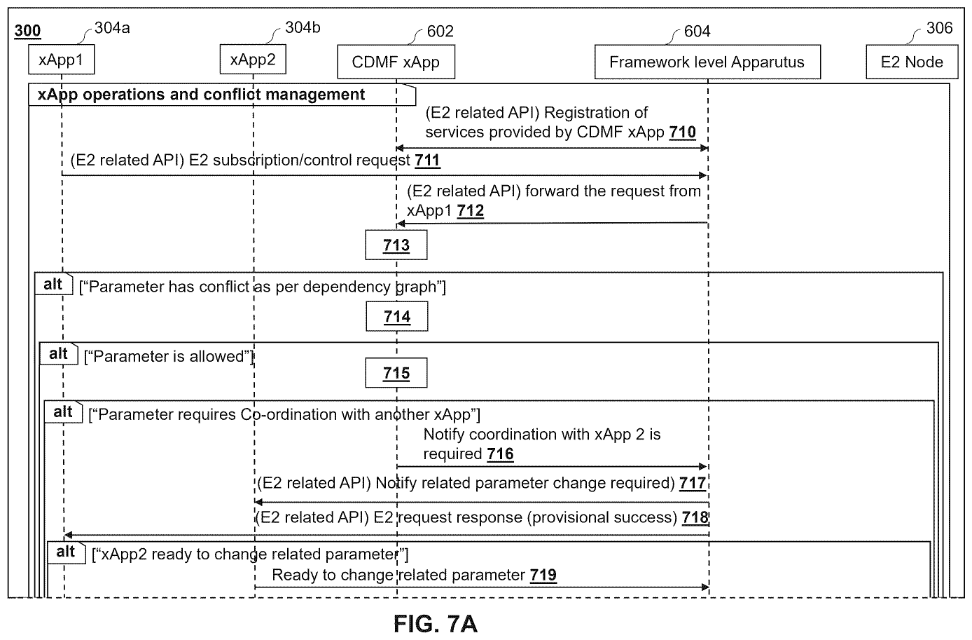

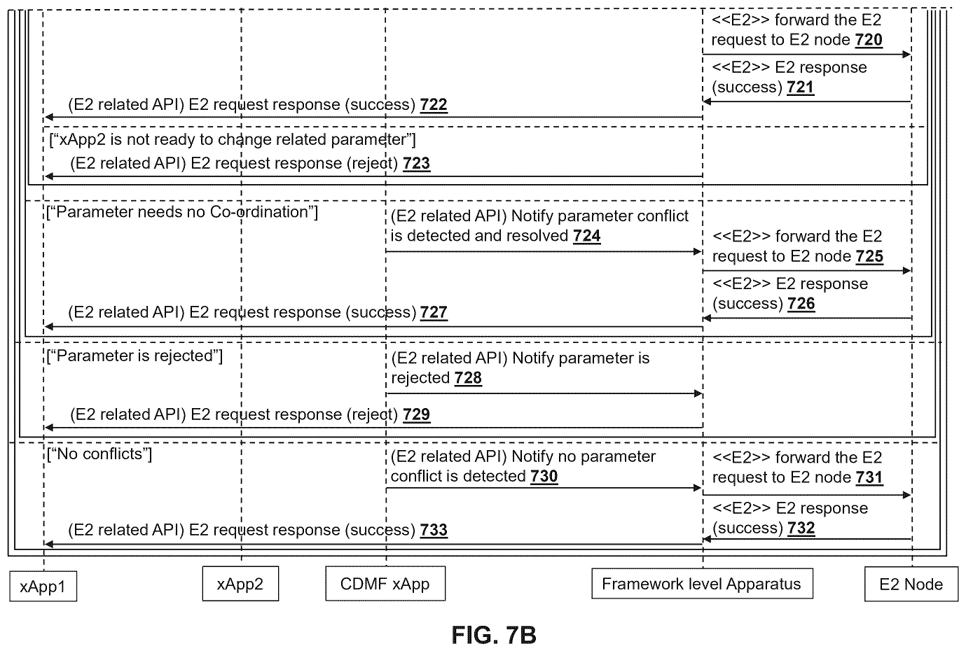

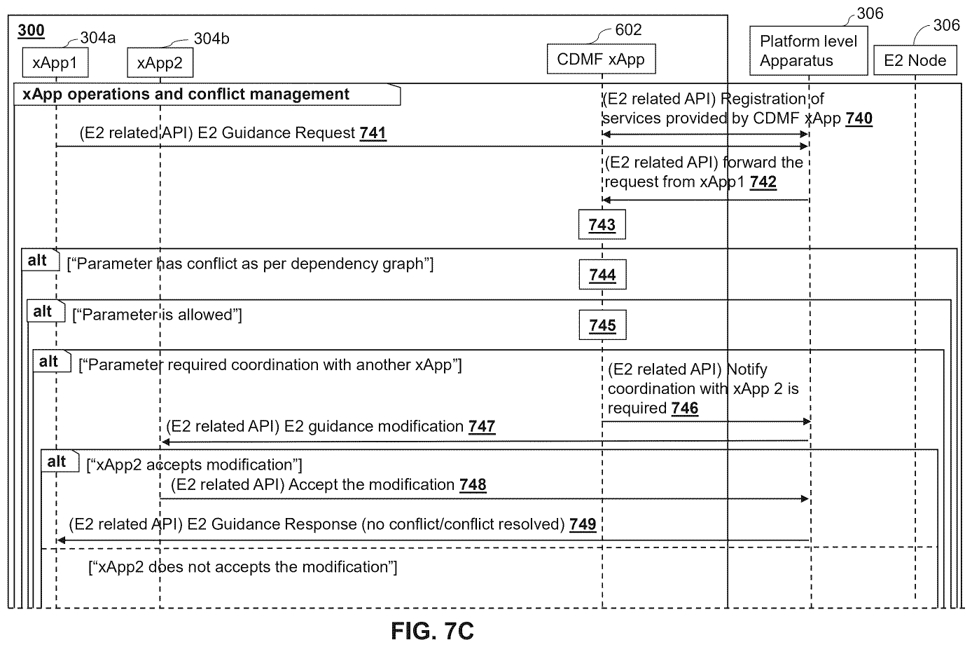

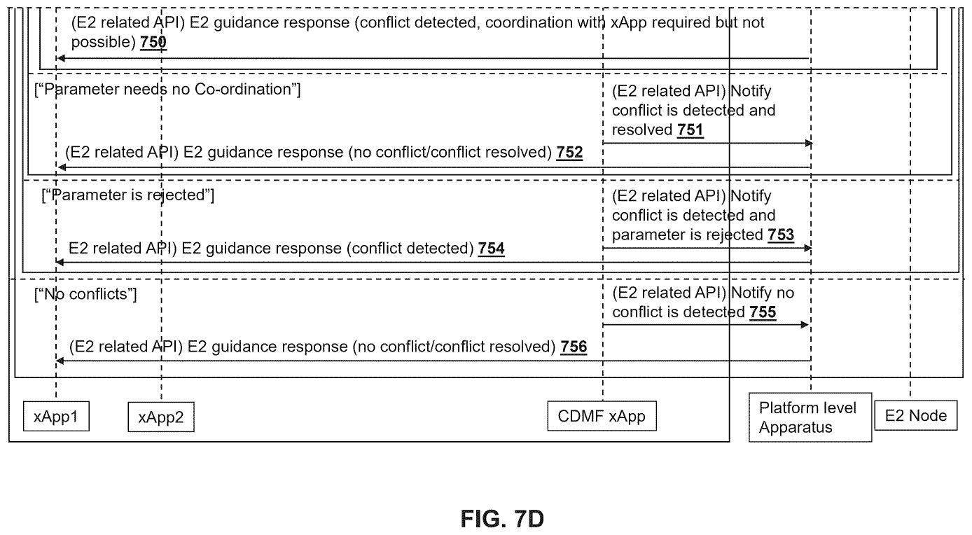

The near-RT RIC 300 routes every E2 subscription request and E2 control request to the CDMF xApp 602. FIGS. 7A-7B illustrate the process flow among the xApps 304a-304b, the platform layer apparatus 604, and the CDMF xApp 602 for E2 subscription and control requests. The near-RT RIC 300 may be in communication with the E2 node 306 and may include components such as the xApp 304a (alternatively referred to as xApp1), the xApp 304b (alternatively referred to as xApp2), the CDMF xApp 602, and the platform layer apparatus 604 As seen in FIGS. 7A-7B, at step 710, the CDMF xApp 602 and the platform layer apparatus 604 exchange messages for registration of conflict detection and mitigation service provided by CDMF xApp 602. At step 711, the xApp 304a sends an E2 subscription request (parameters and actions) or E2 control request (parameters to change) to the platform layer apparatus 604. At step 712, the platform layer apparatus 604 forwards the request from xApp 304a to the CDMF xApp 602. At step 713, the CDMF xApp 602 checks the parameter dependency model 206 for conflicts.

In case the parameter has conflict as per the parameter dependency model 206, at step 714, the CDMF xApp 602 determines whether the set of mitigation rules 208 allow acceptance of the parameter.

In case the acceptance of the parameter is allowed, at step 715, the CDMF xApp 602 checks whether the parameter requires changing related parameter in another xApp, i.e., the xApp 304b.

In case the parameter requires coordination with xApp 304b, at step 716, the CDMF xApp 602 notifies the platform layer apparatus 604 that coordination with xApp 304b is required with related parameter changes. Further, at step 717, the platform layer apparatus 604 notifies the xApp 304b regarding the requirement of the related parameter change. At step 718, the platform layer apparatus 604 sends an E2 subscription/control response to the xApp 304a indicating provisional success.

In case the xApp 304b is ready to change related parameter, at step 719, the xApp 304b sends a ready to change related parameter message (related parameter accept response) to the platform layer apparatus 604. Further, the platform layer apparatus 604 forwards the E2 subscription/control request to the E2 node 306 at step 720. At step 721, the E2 node 306 sends an E2 subscription/control response to the platform layer apparatus 604 indicating success. Further, at step 722, the platform layer apparatus 604 sends an E2 subscription/control response to the xApp 304a indicating success.

In case the xApp 304b is not ready to change related parameter, at step 723, the platform layer apparatus 604 sends an E2 subscription/control response to the xApp 304a indicating reject.

In case the parameter does not require coordination, at step 724, the CDMF xApp 602 notifies the platform layer apparatus 604 that the conflict is detected and resolved. Further, the platform layer apparatus 604 forwards the E2 subscription/control request to the E2 node 306 at step 725. At step 726, the E2 node 306 sends the E2 subscription/control response to the platform layer apparatus 604 indicating success. Further, at step 727, the platform layer apparatus 604 sends the E2 subscription/control response to the xApp 304a indicating success.

In case the parameter is rejected, at step 728, the CDMF xApp 602 notifies the platform layer apparatus 604 that the parameter is rejected. Further, at step 729, the platform layer apparatus 604 sends an E2 subscription/control response to the xApp 304a indicating reject.

In case of no conflict, at step 730, the CDMF xApp 602 notifies the platform layer apparatus 604 that no conflict is detected. Further, the platform layer apparatus 604 forwards the E2 subscription/control request to the E2 node 306 at step 731. At step 732, the E2 node sends an E2 subscription/control response to the platform layer apparatus 604 indicating success. Further, at step 733, the platform layer apparatus 604 sends an E2 subscription/control response to the xApp 304a indicating success.

FIGS. 7C-7D illustrate the process flow among the xApps 304a-304b, the platform layer apparatus 604, and the CDMF xApp 602 for E2 guidance requests. The near-RT RIC 300 may be in communication with the E2 node 306 and may include components such as xApp 304a, xApp 304b, CDMF xApp 602, and platform layer apparatus 604.

At step 740, the CDMF xApp 602 and the platform layer apparatus 604 exchange message(s) for registration of conflict detection and mitigation service provided by CDMF xApp 602. At step 741, the xApp 304a sends an E2 Guidance request to the platform layer apparatus 604. At step 742, the platform layer apparatus 604 forwards the request from the xApp 304a to the CDMF xApp 602. At step 743, the CDMF xApp 602 checks the parameter dependency model 206 for conflicts.

In case the parameter has conflict as per the parameter dependency model 206, at step 744, the CDMF xApp 602 determines whether the set of mitigation rules 208 allow acceptance of the parameter.

In case the acceptance of the parameter is allowed, at step 745, the CDMF xApp 602 checks whether the parameter requires changing related parameters in another xApp, i.e., the xApp 304b.

In case the parameter requires coordination with the xApp 304b, at step 746, the CDMF xApp 602 notifies the platform layer apparatus 604 that coordination with the xApp 304b is required with related parameter changes. Further, the platform layer apparatus 604 sends an E2 guidance (modification) message to the xApp 304b at step 747.

In case the xApp 304b accepts the modifications, at step 748, the xApp 304b sends an accept modification message to the platform layer apparatus 604. At step 749, the platform layer apparatus 604 sends an E2 guidance response to the xApp 304a indicating no conflict or conflict resolved.

In case the xApp 304b does not accept the modifications, at step 750, the platform layer apparatus 604 sends an E2 guidance response to the xApp 304a indicating conflict detected and coordination with xApp 304b is required but not possible.

In case the parameter does not require coordination, at step 751, the CDMF xApp 602 notifies the platform layer apparatus 604 that the conflict is detected and resolved. At step 752, the platform layer apparatus 604 sends an E2 guidance response to the xApp 304a indicating no conflict or conflict resolved.

In case the parameter is rejected, at step 753, the CDMF xApp 602 notifies the platform layer apparatus 604 that conflict is detected, and the parameter is rejected. At step 754, the platform layer apparatus 604 sends an E2 guidance response to the xApp 304a indicating conflict detected.

In case of no conflict, at step 755, the CDMF xApp 602 notifies the platform layer apparatus 604 that no conflict is detected. At step 756, the platform layer apparatus 604 sends an E2 guidance response to the xApp 304a indicating no conflict or conflict resolved.

The CDMF xApp 602 performs the conflict detection and mitigation based on the parameter dependency model 206 and set of mitigation rules 208. This approach helps reduce the complexity of the platform/framework implementation for conflict management. Furthermore, conflict detection and mitigation functions could be tightly coupled with the applications onboarded to the near-RT RIC 300 which will be frequently updated by application vendors, and further, moving it to the application layer helps to improve the life cycle management efficiency and multi-vendor interoperability. Moreover, as the CDMF xApp 602 can decode E2 subscription or E2 control requests from other xApps, the onboarding of the CDMF xApp 602 into the near-RT RIC 300 is based on at least one of a trusted certificate and OAuth2.0 token.

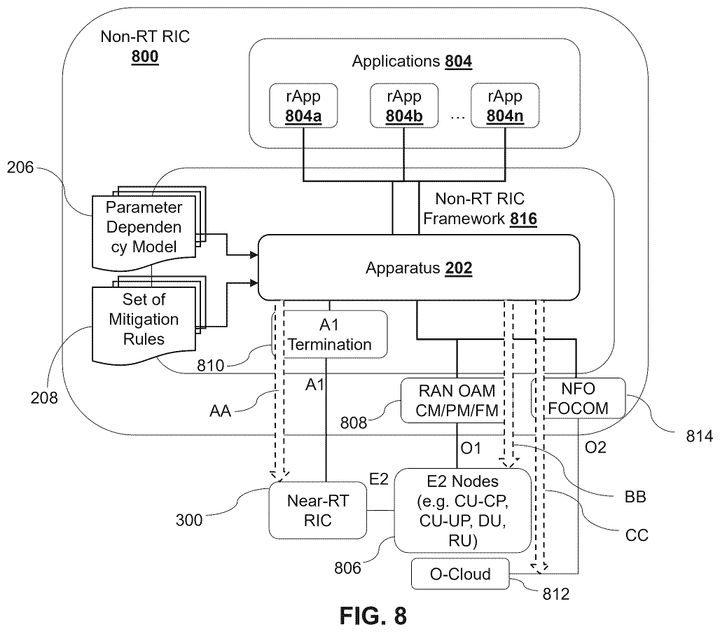

In some embodiments, the apparatus 202 can be implemented in the non-RT RIC when the network controller 200 is the non-RT RIC. FIG. 8 illustrates a block diagram of the network controller 200 when the network controller 200 is the non-RT RIC 800, in accordance with an embodiment of the present disclosure. The non-RT RIC 800 comprises the components as described above for the network controller 200 with reference to FIG. 2 and all of the components are not depicted for sake of brevity. The non-RT RIC may be associated with the SMO. The non-RT RIC 800 comprises the apparatus 202 for parameter conflict detection, mitigation, and request handling in the communication network in order to solve direct and indirect conflicts. When the network controller 200 is the non-RT RIC 800, the plurality of RAN function applications 204 includes a plurality of rApps 804a, 804b, . . . 804n (collectively referred to as ‘rApps 804’). The apparatus 202 may be in communication with the plurality of rApps 804 over an R1 interface. The non-RT RIC 800 may further be communicatively coupled with controlled network functions, i.e., E2 nodes 806 via O1 interface. The E2 nodes 806 may include CU-CP, CU-UP, and DU. In an embodiment, the non-RT RIC 800 may be communicatively coupled with the E2 nodes 806 via RAN OAM Configuration Management (CM)/Performance Management (PM)/Fault Management (FM) unit 808 configured to obtain performance information related to the network, obtain the current configuration of the network, and provision changes to configurations of the network.

The apparatus 202 may further be in communication with the near-RT RIC 300 (shown in FIG. 3) via an A1 interface. In an embodiment, the non-RT RIC 800 may be communicatively coupled with the near-RT RIC 300 via an A1 termination unit 810. Further, the apparatus 202 may be in communication with an O-cloud 812 over an O2 interface. In an embodiment, the non-RT RIC 800 may be communicatively coupled with the O-cloud 812 via Network Function Orchestrator (NFO) Federated O-Cloud Orchestration and Management (FOCOM) unit 814 configured to manage resources in O-cloud while receiving services from Infrastructure Management Services (IMS) associated with the O-cloud. Further, the NFO FOCOM unit 814 may be configured to manage distribution of O-cloud software and providing orchestration for O-cloud life cycle processes. In the illustrated embodiment, the apparatus 202 is included in the non-RT RIC 800 at a framework level, i.e., forming a part of a non-RT RIC framework 816.

The apparatus 202 in the non-RT RIC 800 is associated with the parameter dependency model 206 and the set of mitigation rules 208. In an embodiment, the parameter dependency model 206 and the set of mitigation rules 208 may be generated and linked to the apparatus 202 during network design by an operator. In another embodiment, the parameter dependency model 206 and the set of mitigation rules 208 are generated by one or more of the rApps 804 based on a generative AI model that may be stored in the memory 214.

As described above, the parameter dependency model 206 may be utilized to detect conflicts. The parameter dependency model 206 defines dependencies among a plurality of parameters associated with the plurality of rApps 804. In an embodiment, the parameter dependency model 206 defines dependencies among one or more of O1 parameters, O2 parameters, and A1 parameters associated with the plurality of rApps 804.

In some embodiments, one or more of the plurality of rApps 804 may transmit a request to the apparatus 202. For instance, the apparatus 202 may receive a request from the rApp 804a indicating a change in one or more parameters associated with the non-RT RIC 800. Upon receiving the request from the rApp 804a, the apparatus 202 may refer to the parameter dependency model 206 for detecting conflicts which may occur as a result of the change in the one or more parameters. In case the apparatus 202 determines that a conflict may occur, one or more reconciliation actions may be triggered based on the set of mitigation rules 208.

In an embodiment, the one or more reconciliation actions include one or more of stopping one or more of the plurality of rApps 804, adjusting a configuration of one or more of the plurality of rApps 804, and adjusting an operation of E2 nodes 806 associated with non-RT RIC 800.

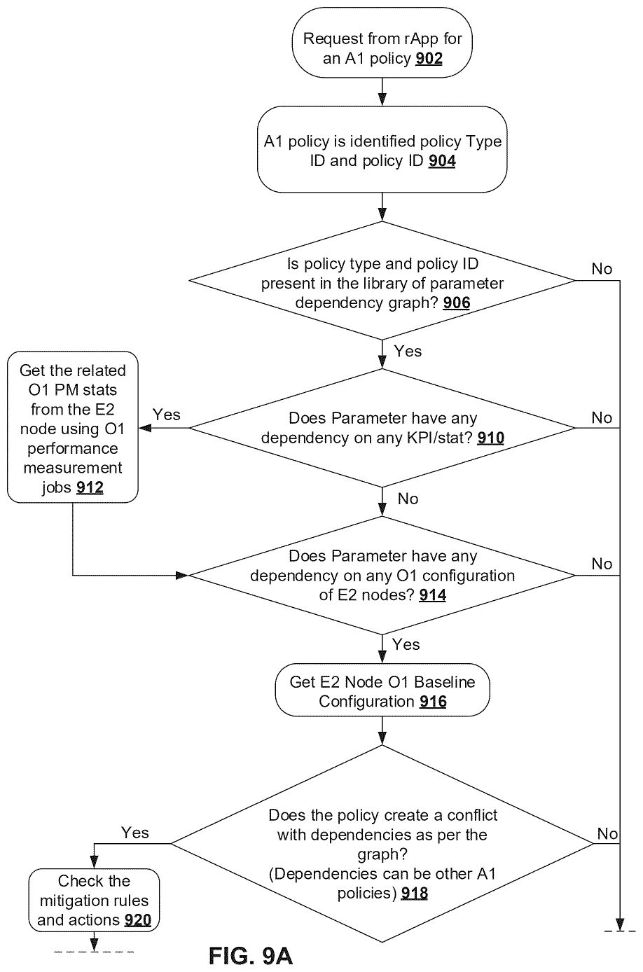

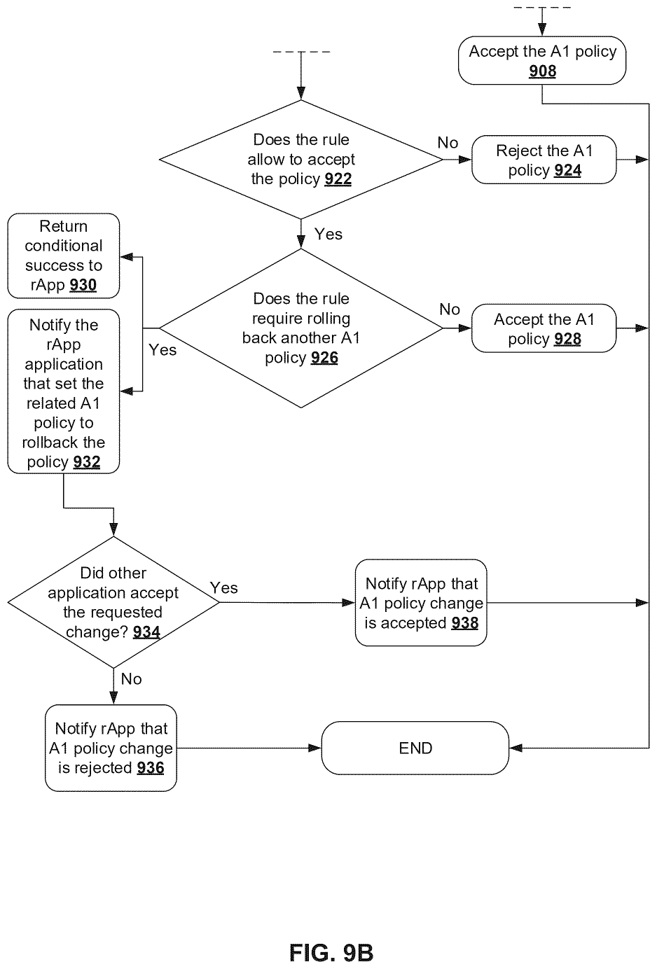

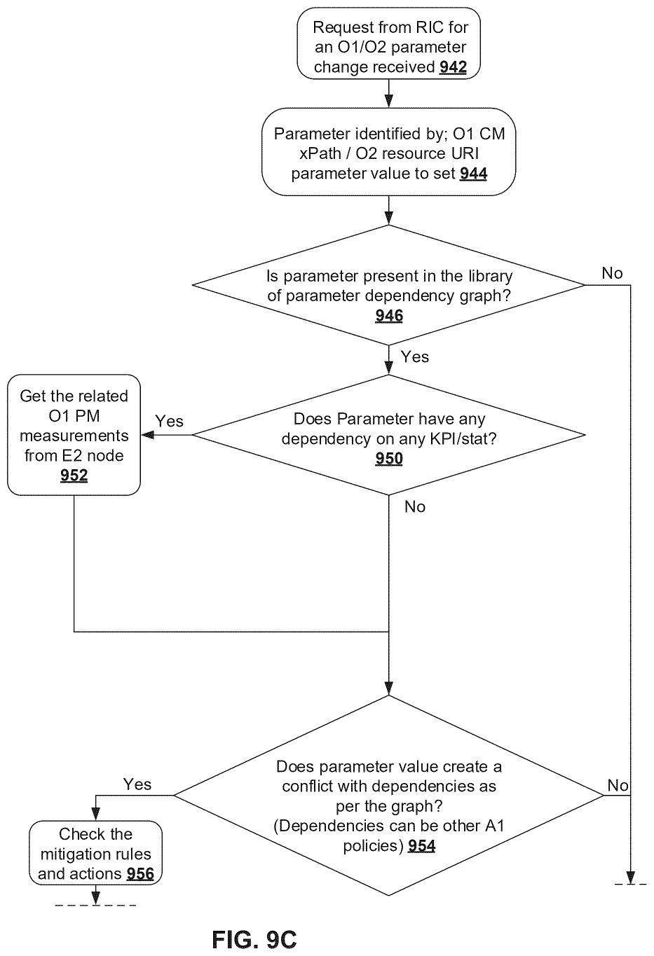

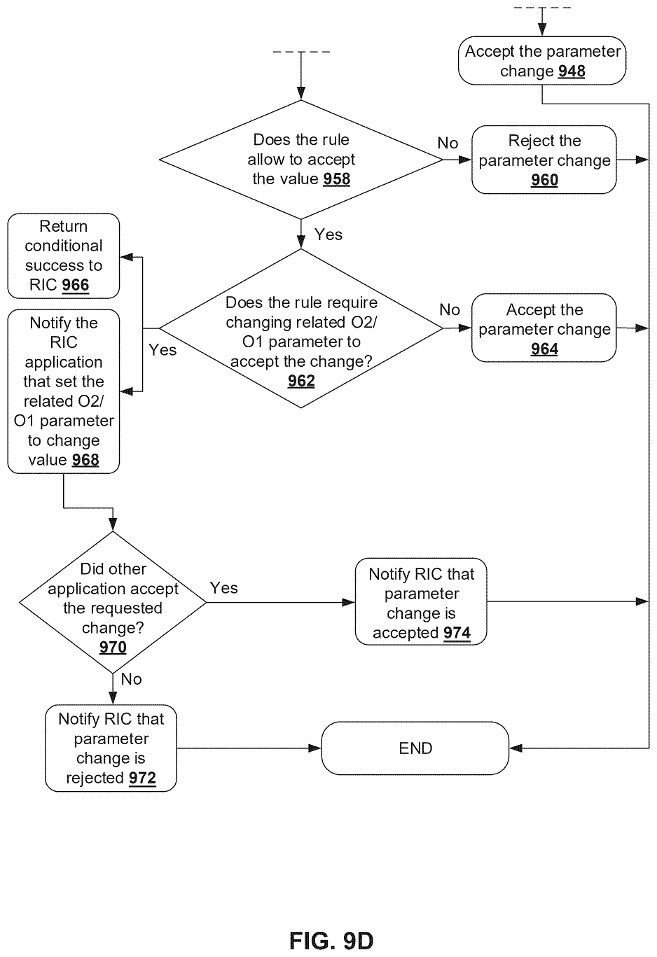

In an embodiment, the apparatus 202 may identify the one or more parameters in the request received from the rApp 804a. In an embodiment, the apparatus 202 may identify A1 policy dependencies and detect conflicts in A1 parameters, as depicted by arrow AA and described with respect to FIGS. 9A-9B further below. In another embodiment, the apparatus 202 may detect conflicts in at least one of O1 and O2 parameters, as depicted by arrows BB and CC, and as described with respect to FIGS. 9C-9D further below.

In an embodiment, the apparatus 202 may determine whether the identified one or more parameters are present in the parameter dependency model 206 and whether the one or more parameters have a dependency on one or more of KPIs, policy parameters, configuration parameters, and control parameters. The apparatus 202 may then determine whether a conflict will occur. In an embodiment, when the apparatus 202 determines that the conflict will occur, the request may be rejected. In an embodiment, when the apparatus 202 determines that the conflict will not occur, the request may be accepted, in that, the change in the one or more parameters may be accepted. In an embodiment, in case of no detected conflicts, a success indication may be sent to the rApp 804a and the received request may be logged in the memory 214 for comparison against future requests.

In an embodiment, the apparatus 202 may be configured to determine that an acceptance of the change in the one or more parameters is allowed based on the set of mitigation rules 208. Further, the apparatus 202 may determine a requirement of change in a related parameter associated with at least one other rApp, for example, rApp 804b. The apparatus 202 may then send a related parameter request to the rApp 804b indicating a request to accept the change in the related parameter. In an embodiment, the rApp 804b may accept the change in the related parameter. In such a scenario, the apparatus 202 may receive a related parameter accept response from the rApp 804b indicating that the change in the related parameter is accepted. Upon receiving the related parameter accept response, the apparatus 202 accepts the change in the one or more parameters in the request sent by the rApp 804a. The rApp 804a may then send the request to the E2 nodes 806 upon receiving the success indication from the apparatus 202.

In an embodiment, the rApp 804b may reject the change in the related parameter. In such a scenario, the apparatus 202 may receive a related parameter reject response from the rApp 804b indicating that the change in the related parameter is rejected. Upon receiving the related parameter reject response, the apparatus 202 rejects the change in the one or more parameters in the request sent by the rApp 804a. Thus, in non-RT RIC 800, all subscriptions for parameter change events as well as requests for changing parameters pass through the apparatus 202 for conflict detection and mitigation.

FIGS. 9A-9B illustrate a detailed process flow employed by the non-RT RIC 800 to use the parameter dependency model 206 and the set of mitigation rules 208 for conflict detection and mitigation for A1 parameters, in accordance with an embodiment of the present disclosure. The apparatus 202 may identify A1 policy dependencies. The parameter dependency model 206 may model A1 policy types and dependent A1 policy IDs while the set of mitigation rules 208 may define the mitigation actions corresponding to the parameter dependency model 206.

Initially, at step 902, a request for A1 policy may be received by the apparatus 202 from the plurality of rApps 804. At step 904, the A1 policy may be identified based on policy type ID and policy ID.

At step 906, it is determined whether the policy type and policy ID are present in the library of the parameter dependency model 206. If the policy type and policy ID are not present in the parameter dependency model 206, the A1 policy is accepted at step 908 and the process ends. If the policy type and policy ID are present in the parameter dependency model 206, it is determined whether there is a dependency on any KPI or stat at step 910. In case of no dependency, the process moves to step 914. In case of dependency, at step 912, the related O1 performance measurement (PM) stats may be obtained from the associated E2 node 806 using O1 performance measurement jobs and the process moves to step 914.

At step 914, it is determined whether there is any dependency on O1 configuration of associated E2 nodes 806. In case of no dependency, the A1 policy is accepted at step 908 and the process ends. In case of dependency, the E2 node O1 baseline configuration is obtained at step 916. At step 918, it is determined whether the policy creates a conflict with dependencies as per the parameter dependency model 206. The dependencies can be, for instance, other A1 policies. In case of no conflicts, the A1 policy is accepted at step 908.

In case of conflicts, the set of mitigation rules 208 are checked at step 920. If the set of mitigation rules 208 do not allow acceptance of policy at step 922, then, at step 924 the A1 policy is rejected. If the set of mitigation rules 208 allows acceptance of the policy, then, at step 926 it is determined whether the set of mitigation rules 208 require rolling back another A1 policy. If no rollback is required, then, at step 928 the A1 policy is accepted. If rollback is required, then, at step 930, a conditional success indication is sent to the rApp 804a, and at step 932, the rApp application that set the related A1 policy is notified to roll-back the policy. At step 934, it is determined whether other applications, such as the rApp 804b, have accepted the requested change. In case the rApp 804b does not accept the requested change, then, at step 936 the rApp 804a is notified that the A1 policy change is rejected. In case rApp 804b has accepted the requested change, then, at step 938, the rApp 804a is notified that the A1 policy change is accepted. The process then ends.

FIGS. 9C-9D illustrate a detailed process flow employed by the non-RT RIC 800 to use the parameter dependency model 206 and the set of mitigation rules 208 for conflict detection and mitigation for O1 and O2 parameters, in accordance with an embodiment of the present disclosure. In an embodiment, the O1 parameters may be identified by xPath of the O1 configuration. In an embodiment, the O2 parameters may be identified by the HTTP resource Uniform Resource Identifier (URI) of the configuration.

Initially, at step 942, a request for O1/O2 parameter change may be received from the non-RT RIC 800. At step 944, the parameter may be identified based on O1 CM xPath or O2 resource URI.

At step 946, it is determined whether the parameter is present in the library of the parameter dependency model 206. If the parameter is not present in the parameter dependency model 206, the parameter change is accepted at step 948 and the process ends. If the parameter is present in the parameter dependency model 206, it is determined whether the parameter has dependency on any KPI or stat at step 950. In case of no dependency, the process moves to step 954. In case of dependency, at step 952, the related O1 performance measurement (PM) measurements may be obtained from the associated E2 nodes 806 and the process moves to step 954.

At step 954, it is determined whether the parameter value creates a conflict with dependencies as per the parameter dependency model 206. The dependencies can be, for instance, other O2 or O1 parameters or KPIs. In case of no conflicts, the parameter change is accepted at step 948. In case of conflicts, the set of mitigation rules 208 are checked at step 956.

If the set of mitigation rules 208 do not allow acceptance of value at step 958, then, at step 960 the parameter change is rejected. If the set of mitigation rules 208 allow acceptance of value, then, at step 962, it is determined whether the set of mitigation rules 208 require changing related O2/O1 parameters to accept the change. If no change is required, then, at step 964 the parameter change is accepted. If change is required, then, at step 966, a conditional success indication is sent to the non-RT RIC 800, and at step 968, the rApp 804a is notified to set the related O2/O1 parameter to change value. At step 970, it is determined whether other applications, such as the rApp 804b, have accepted the requested change. In case the rApp 804b has not accepted the requested change, then, at step 972 the non-RT RIC 800 is notified that the parameter change is rejected. In case the rApp 804b has accepted the requested change, then, at step 974 the non-RT RIC 800 is notified that the parameter change is accepted. The process then ends.

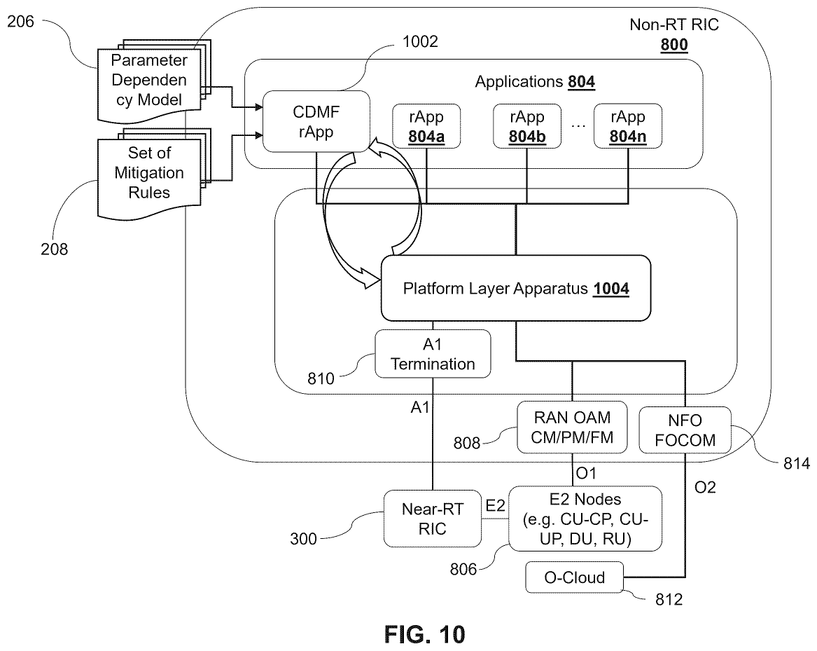

FIG. 10 illustrates another block diagram of the network controller 200 when the network controller 200 is the non-RT RIC 800, in accordance with another embodiment of the present disclosure. The non-RT RIC 800 comprises the components as described above for the non-RT RIC 800 with reference to FIG. 8. The non-RT RIC 800 depicted in FIG. 10 may correspond to the non-RT RIC 800 illustrated in FIG. 8, however, in the illustrated embodiment of FIG. 10, the apparatus 202 (corresponding to apparatus 202 of FIG. 3) itself is implemented at an application level as a special rApp, as shown by block 1002. The special rApp may be referred to as CDMF rApp 1002 hereinafter. The functions of the apparatus 202 mentioned above may be implemented using the CDMF rApp 1002. Further, the non-RT RIC 800 may include a platform layer apparatus 1004.

The CDMF rApp 1002 performs the conflict detection and mitigation based on the parameter dependency model 206 and the set of mitigation rules 208. In an embodiment, the platform layer apparatus 1004 detects some simple direct conflict at the platform level. The platform layer apparatus 1004 forwards RI RAN OAM related service requests, O2 related service requests, or A1 related service requests service requests from all the rApps 804 under conflict management to the CDMF rApp 1002 for further processing, which may include detecting application-level conflicts, indirect conflicts, and implicit conflicts. The conflict detection and mitigation as per the illustrated embodiment allows reducing the complexity of the platform implementation for conflict management. Furthermore, conflict detection and mitigation functions could be tightly coupled with the applications onboarded to the non-RT RIC platform which will be frequently updated by application vendors, moving it to the application layer will help to improve the life cycle management efficiency and multi-vendor interoperability.

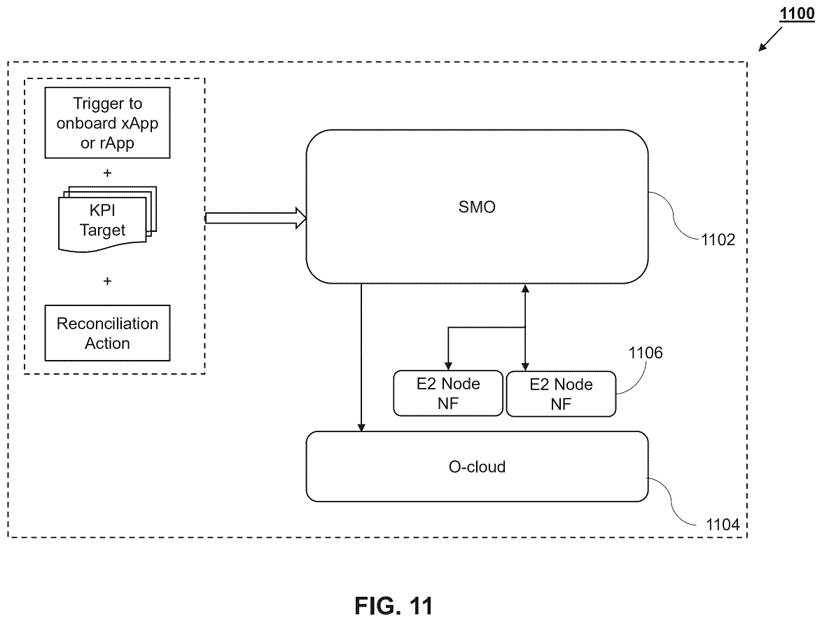

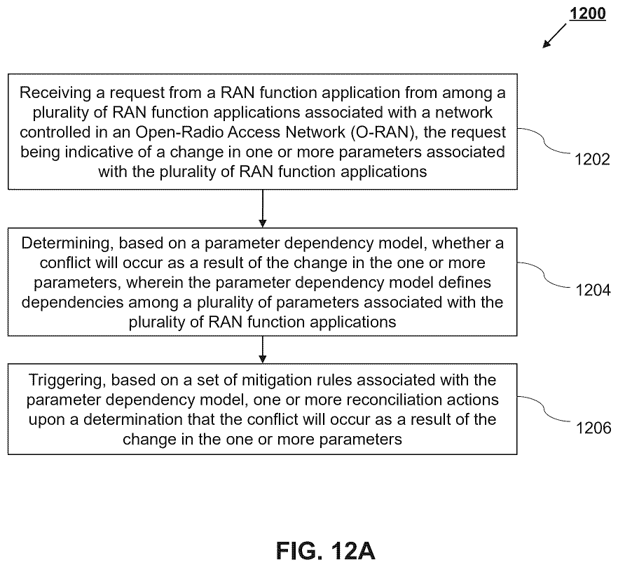

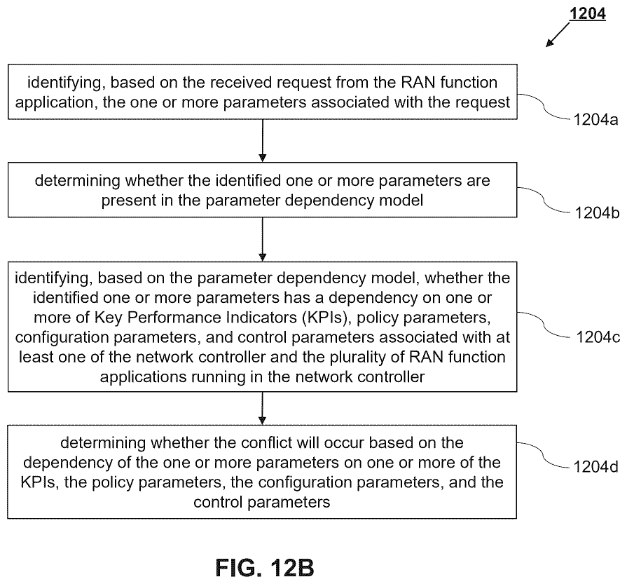

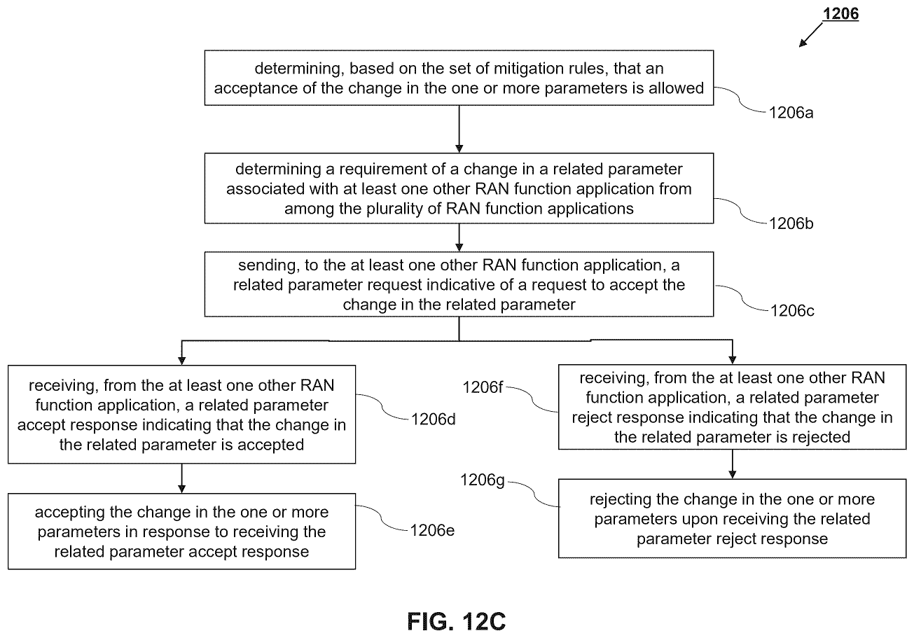

With respect to implicit conflicts, the present disclosure provides a framework for continuous monitoring of KPIs and reconciling back to a stable state upon determination of a bad state of the KPIs. FIG. 11 depicts a framework 1100 for reconciliation in accordance with an embodiment of the present disclosure. In an embodiment, the framework 1100 may be associated with the network controller 200, such as the near-RT RIC 300 or the non-RT RIC 800. In an embodiment, the framework 1100 may include an SMO 1102 in connection with an O-cloud 1104 and E2 Node Network Functions (NFs) 1106. In an embodiment, the SMO 1102 may be configured to deploy the RAN function applications 204, such as the xApps 304, through an interface of the O-cloud 1104. In an embodiment, the interface may be an O2 DMS interface. Based on the framework 1100, the list of KPIs to be monitored and the mitigation actions to be performed in case the KPIs are not met may be determined.

In an embodiment, a RAN function application from among the plurality of RAN function applications 204 may be onboarded through the SMO 1102. Further, the list of KPIs to monitor and the KPI target values may be fed into the SMO 1102 in a suitable format, such as, JSON or Extensible Markup Language (XML). After deployment of the RAN function application, the SMO 1102 may be configured to periodically fetch measurements or get streaming measurements from associated E2 nodes and monitor the KPI values. The KPI values may be compared with pre-defined target values. In an embodiment, the target values are stored in the memory 214. Upon a determination that the KPI values are not meeting the pre-defined target values consistently over multiple monitoring periods, then the SMO 1102 may be configured to initiate reconciliation actions. In an embodiment, the monitoring periods may be, for instance, 5 monitoring periods of a predefined time duration. In an embodiment, the reconciliation actions to trigger may be fed into SMO 1102 through a JSON/XML document. Accordingly, the effectiveness of the RAN function applications 204 and KPI degradation is monitored. The KPIs can be monitored after conflict mitigation to ensure that the mitigation does not lead to a detrimental impact to the communication network. In case the KPIs are degrading, rollback actions may be enabled, thereby solving implicit conflicts.

FIG. 12A illustrates a process flow depicting a method 1200 for conflict detection and mitigation, in accordance with an embodiment of the present disclosure. In one embodiment, the steps of the method 1200 may be performed by the apparatus 202, as discussed above with reference to FIGS. 2-10.

Initially, at step 1202, a request from a RAN function application (for example, RAN function application 204a) from among the plurality of RAN function applications 204 associated with a network controlled in the O-RAN is received. The request may be indicative of a change in one or more parameters associated with the plurality of RAN function applications 204.

At step 1204, a determination is whether a conflict will occur as a result of the change in the one or more parameters. The determination may be made based on the parameter dependency model 206. The parameter dependency model defines dependencies among a plurality of parameters associated with the plurality of RAN function applications 204.

In an embodiment, to determine whether the conflict will occur, the method 1200 may comprise steps 1204a-1204d depicted in FIG. 12B. At step 1204a, the one or more parameters associated with the request are identified based on the received request from the RAN function application. At step 1204b, a determination is made whether the identified one or more parameters are present in the parameter dependency model 206. At step 1204c, the method comprises identifying whether the one or more parameters has a dependency on one or more of KPIs, policy parameters, configuration parameters, and control parameters associated with at least one of the network controller 200 and the plurality of RAN function applications 204 running in the network controller 200. The dependency of the one or more parameters may be determined based on the parameter dependency model 206. At step 1204d, a determination is made whether the conflict will occur based on the dependency of the one or more parameters on one or more of the KPIs, the policy parameters, the configuration parameters, and the control parameters.

In an embodiment, the change in the one or more parameters is accepted upon a determination that the conflict will not occur as a result of the change in the one or more parameters.

Referring to FIG. 12A, at step 1206, upon a determination that the conflict will occur as a result of the change in the one or more parameters, one or more reconciliation actions are triggered based on the set of mitigation rules 208.

In an embodiment, the one or more reconciliation actions include one or more of stopping one or more of the plurality of RAN function applications 204, adjusting a configuration of one or more of the plurality of RAN function applications 204, and adjusting an operation of E2 nodes associated with the network controller 200.

In an embodiment, to trigger the one or more reconciliation actions, the method 1200 may comprise steps 1206a-1206g depicted in FIG. 12C. At step 1206a, the method comprises determining, based on the set of mitigation rules 208, that an acceptance of the change in the one or more parameters is allowed. At step 1206b, the method comprises determining a requirement of a change in a related parameter associated with at least one other RAN function application (for example, RAN function application 204b) from among the plurality of RAN function applications 204. At step 1206c, the method comprises sending a related parameter request indicative of a request to accept the change in the related parameter to the at least one other RAN function application (RAN function application 204b).

The at least one other RAN function application may accept or reject the request to change the related parameter. At step 1206d, the method comprises receiving a related parameter accept response from the at least one other RAN function application indicating that the change in the related parameter is accepted. At step 1206e, the method comprises accepting the change in the one or more parameters in response to receiving the related parameter accept response.

At step 1206f, the method comprises receiving a related parameter reject response from the at least one other RAN function application indicating that the change in the related parameter is rejected. At step 1206g, the method comprises rejecting the change in the one or more parameters in response to receiving the related parameter reject response.

In an embodiment, to trigger the one or more reconciliation actions, the method comprises determining that an acceptance of the change in the one or more parameters is disallowed based on the set of mitigation rules 208. Further, the method comprises rejecting the change in the one or more parameters.

While the above-discussed steps in FIGS. 12A-12C are shown and described in a particular sequence, the steps may occur in variations to the sequence in accordance with various embodiments. Further, a detailed description related to the various steps of FIGS. 12A-12C is already covered in the description related to FIGS. 2-10 and is omitted herein for the sake of brevity.

The present disclosure provides apparatus and method for conflict detection and mitigation. Instead of a hard-coded logic, a flexible configuration for conflict detection, mitigation, and monitoring is provided. The parameter dependency model and set of mitigation rules may be loaded to the apparatus and integrated with the network controllers, i.e., the near-RT RIC and the non-RT RIC. The use of parameter dependency model and set of mitigation rules enable solving direct and indirect conflicts.
[1] An apparatus associated with a network controller in an Open-Radio Access Network (O-RAN), the apparatus being configured to:
receive a request from a RAN function application from among a plurality of RAN function applications associated with the network controller, the request being indicative of a change in one or more parameters associated with the plurality of RAN function applications;
determine, based on a parameter dependency model associated with the apparatus, whether a conflict will occur as a result of the change in the one or more parameters, wherein the parameter dependency model defines dependencies among a plurality of parameters associated with the plurality of RAN function applications; and
trigger, based on a set of mitigation rules associated with the parameter dependency model, one or more reconciliation actions upon a determination that the conflict will occur as a result of the change in the one or more parameters.
[2] The apparatus described in [1], wherein to determine whether the conflict will occur, the apparatus is configured to:
identify, based on the received request from the RAN function application, the one or more parameters associated with the request;
determine whether the identified one or more parameters are present in the parameter dependency model;
identify, based on the parameter dependency model, whether the identified one or more parameters has a dependency on one or more of Key Performance Indicators (KPIs), policy parameters, configuration parameters, and control parameters associated with at least one of the apparatus, the controlled network functions (E2 nodes) and the plurality of RAN function applications running in the network controller; and
determine whether the conflict will occur based on the dependency of the one or more parameters on one or more of the KPIs, the policy parameters, the configuration parameters, and the control parameters.
[3] The apparatus described in any one of [1] or [2], wherein:
the policy parameters, the configuration parameters, and the control parameters are exposed as parameters through one or more open interfaces,
the one or more open interfaces include one or more of A1 interface, O1 interface, and E2 interface, and
the controlled network functions (E2 nodes) include one or more of a RAN Distributed Unit (DU), RAN Centralized Unit Control Plane (CU-CP), and RAN Centralized Unit User Plane (CU-UP).
[4] The apparatus described in any one of [1]-[3], wherein:
network controller is one of a Near-Real Time Radio Access Network Intelligent Controller (near RT-RIC) or a Non-Real Time Radio Access Network Intelligent Controller (non RT-RIC),
when the network controller is the near RT-RIC, the plurality of RAN function applications include xApps, and
when the network controller is the non RT-RIC, the plurality of RAN function applications include rApps.
[5] The apparatus described in [1], wherein the apparatus is further configured to accept the change in the one or more parameters upon a determination that the conflict will not occur as a result of the change in the one or more parameters.
[6] The apparatus described in [1], wherein to trigger the one or more reconciliation actions, the apparatus is configured to:
determine, based on the set of mitigation rules, that an acceptance of the change in the one or more parameters is allowed;
determine a requirement of a change in a related parameter associated with at least one other RAN function application from among the plurality of RAN function applications;
send, to the at least one other RAN function application, a related parameter request indicative of a request to accept the change in the related parameter;
receive, from the at least one other RAN function application, a related parameter accept response indicating that the change in the related parameter is accepted; and
accept the change in the one or more parameters in response to receiving the related parameter accept response.
[7] The apparatus described in [5], wherein the apparatus is configured to:
receive, from the at least one other RAN function application, a related parameter reject response indicating that the change in the related parameter is rejected; and
reject the change in the one or more parameters upon receiving the related parameter reject response.
[8] The apparatus described in [1], wherein to trigger the one or more reconciliation actions, the apparatus is configured to:
determine, based on the set of mitigation rules, that an acceptance of the change in the one or more parameters is disallowed; and
reject the change in the one or more parameters.
[9] The apparatus described in any one of [1]-[8], wherein:
when the network controller is the near RT-RIC, the apparatus is included in the near-RT RIC at one of a framework level or an application level, and
the parameter dependency model defines dependencies among E2 parameters and O1 parameters.
[10] The apparatus described in any one of [1]-[8], wherein:
when the network controller is the non RT-RIC, the apparatus is included in the non-RT RIC at one of a framework level or an application level, and
the parameter dependency model defines dependencies among one or more of O1 parameters, O2 parameters, and A1 parameters.
[11] The apparatus described in any one of [1]-[10], wherein the parameter dependency model and the set of mitigation rules are encoded in a machine-readable data format, and wherein the parameter dependency model is configured to be one of:
automatically generated by one or more of plurality of RAN function applications based on a generative Artificial Intelligence (AI) model, or
generated and linked to the apparatus during network design by an operator.
[12] The apparatus described in [1], wherein the one or more reconciliation actions include one or more of stopping one or more of the plurality of RAN function applications, adjusting a configuration of one or more of the plurality of RAN function applications, and adjusting an operation of E2 nodes associated with the network controller.
[13] A method comprising:
receiving a request from a RAN function application from among a plurality of RAN function applications associated with a network controlled in an Open-Radio Access Network (O-RAN), the request being indicative of a change in one or more parameters associated with the plurality of RAN function applications;
determining, based on a parameter dependency model, whether a conflict will occur as a result of the change in the one or more parameters, wherein the parameter dependency model defines dependencies among a plurality of parameters associated with the plurality of RAN function applications; and
triggering, based on a set of mitigation rules associated with the parameter dependency model, one or more reconciliation actions upon a determination that the conflict will occur as a result of the change in the one or more parameters.
[14] The method described in [13], wherein determining whether the conflict will occur comprises:
identifying, based on the received request from the RAN function application, the one or more parameters associated with the request;
determining whether the identified one or more parameters are present in the parameter dependency model;
identifying, based on the parameter dependency model, whether the identified one or more parameters has a dependency on one or more of Key Performance Indicators (KPIs), policy parameters, configuration parameters, and control parameters associated with at least one of the network controller and the plurality of RAN function applications running in the network controller; and
determining whether the conflict will occur based on the dependency of the one or more parameters on one or more of the KPIs, the policy parameters, the configuration parameters, and the control parameters.
[15] The method described in any one of [13]-[14], further comprising:
accepting the change in the one or more parameters upon a determination that the conflict will not occur as a result of the change in the one or more parameters.
[16] The method described in [13], wherein triggering the one or more reconciliation actions comprises:
determining, based on the set of mitigation rules, that an acceptance of the change in the one or more parameters is allowed;
determining a requirement of a change in a related parameter associated with at least one other RAN function application from among the plurality of RAN function applications;
sending, to the at least one other RAN function application, a related parameter request indicative of a request to accept the change in the related parameter;
receiving, from the at least one other RAN function application, a related parameter accept response indicating that the change in the related parameter is accepted; and
accepting the change in the one or more parameters in response to receiving the related parameter accept response.
[17] The method described in [16], comprising:
receiving, from the at least one other RAN function application, a related parameter reject response indicating that the change in the related parameter is rejected; and
rejecting the change in the one or more parameters upon receiving the related parameter reject response.
[18] The method described in [13], wherein triggering the one or more reconciliation actions comprises:
determining, based on the set of mitigation rules, that an acceptance of the change in the one or more parameters is disallowed; and
rejecting the change in the one or more parameters.
[19] The method described in [13], wherein the one or more reconciliation actions include one or more of stopping one or more of the plurality of RAN function applications, adjusting a configuration of one or more of the plurality of RAN function applications, and adjusting an operation of E2 nodes associated with the network controller.
[20] The method described in any one of [13]-[19], wherein:
the policy parameters, the configuration parameters, and the control parameters are exposed as parameters through one or more open interfaces, the one or more open interfaces including one or more of A1 interface, O1 interface, and E2 interface,
the network controller is one of a Near-Real Time Radio Access Network Intelligent Controller (near RT-RIC) or a Non-Real Time Radio Access Network Intelligent Controller (non RT-RIC),
the plurality of RAN function applications includes one of xApps and rApps,
the parameter dependency model and the set of mitigation rules are encoded in a machine-readable data format, and
the parameter dependency model is configured to be one of automatically generated by one or more of plurality of RAN function applications based on a generative Artificial Intelligence (AI) model or generated during network design by an operator.

The embodiments disclosed herein can be implemented through at least one software program running on at least one hardware device and performing network management functions to control the elements. The elements can be at least one of a hardware device, or a combination of hardware devices and software modules.

It is understood that terms including “unit” or “module” at the end may refer to the unit for processing at least one function or operation and may be implemented in hardware, software, or a combination of hardware and software.

While specific language has been used to describe the disclosure, any limitations arising on account of the same are not intended. As would be apparent to a person in the art, various working modifications may be made to the method in order to implement the inventive concept as taught herein.

The drawings and the forgoing description give examples of embodiments. Those skilled in the art will appreciate that one or more of the described elements may well be combined into a single functional element. Alternatively, certain elements may be split into multiple functional elements. Elements from one embodiment may be added to another embodiment. For example, orders of processes described herein may be changed and are not limited to the manner described herein.

Moreover, the actions of any flow diagram need not be implemented in the order shown; nor do all of the acts necessarily need to be performed. Also, those acts that are not dependent on other acts may be performed in parallel with the other acts. The scope of embodiments is by no means limited by these specific examples. Numerous variations, whether explicitly given in the specification or not, such as differences in structure, dimension, and use of material, are possible. The scope of embodiments is at least as broad as given by the following claims.

Benefits, other advantages, and solutions to problems have been described above with regard to specific embodiments. However, the benefits, advantages, solutions to problems, and any component(s) that may cause any benefit, advantage, or solution to occur or become more pronounced are not to be construed as a critical, required, or essential feature or component of any or all the claims.

The foregoing description of the specific embodiments will so fully reveal the general nature of the embodiments herein that others can, by applying current knowledge, readily modify and adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of at least one embodiment, those skilled in the art will recognize that the embodiments herein can be practiced with modification within the spirit and scope of the embodiments as described herein.

We claim:

1. An apparatus associated with a network controller in an Open-Radio Access Network (O-RAN), the apparatus being configured to:
receive a request from a RAN function application from among a plurality of RAN function applications associated with the network controller, the request being indicative of a change in one or more parameters associated with the plurality of RAN function applications;
determine, based on a parameter dependency model associated with the apparatus, whether a conflict will occur as a result of the change in the one or more parameters, wherein the parameter dependency model defines dependencies among a plurality of parameters associated with the plurality of RAN function applications; and
trigger, based on a set of mitigation rules associated with the parameter dependency model, one or more reconciliation actions upon a determination that the conflict will occur as a result of the change in the one or more parameters.

2. The apparatus as claimed in claim 1, wherein to determine whether the conflict will occur, the apparatus is configured to:
identify, based on the received request from the RAN function application, the one or more parameters associated with the request;
determine whether the identified one or more parameters are present in the parameter dependency model;
identify, based on the parameter dependency model, whether the identified one or more parameters has a dependency on one or more of Key Performance Indicators (KPIs), policy parameters, configuration parameters, and control parameters associated with at least one of the apparatus, the controlled network functions (E2 nodes) and the plurality of RAN function applications running in the network controller; and
determine whether the conflict will occur based on the dependency of the one or more parameters on one or more of the KPIs, the policy parameters, the configuration parameters, and the control parameters.

3. The apparatus as claimed in claim 2, wherein:
the policy parameters, the configuration parameters, and the control parameters are exposed as parameters through one or more open interfaces,
the one or more open interfaces include one or more of A1 interface, O1 interface, and E2 interface, and
the controlled network functions (E2 nodes) include one or more of a RAN Distributed Unit (DU), RAN Centralized Unit Control Plane (CU-CP), and RAN Centralized Unit User Plane (CU-UP).

4. The apparatus as claimed in claim 1, wherein:
the network controller is one of a Near-Real Time Radio Access Network Intelligent Controller (near RT-RIC) or a Non-Real Time Radio Access Network Intelligent Controller (non RT-RIC),
when the network controller is the near RT-RIC, the plurality of RAN function applications include xApps, and
when the network controller is the non RT-RIC, the plurality of RAN function applications include rApps.

5. The apparatus as claimed in claim 1, wherein the apparatus is further configured to accept the change in the one or more parameters upon a determination that the conflict will not occur as a result of the change in the one or more parameters.

6. The apparatus as claimed in claim 1, wherein to trigger the one or more reconciliation actions, the apparatus is configured to:
determine, based on the set of mitigation rules, that an acceptance of the change in the one or more parameters is allowed;
determine a requirement of a change in a related parameter associated with at least one other RAN function application from among the plurality of RAN function applications;
send, to the at least one other RAN function application, a related parameter request indicative of a request to accept the change in the related parameter;
receive, from the at least one other RAN function application, a related parameter accept response indicating that the change in the related parameter is accepted; and
accept the change in the one or more parameters in response to receiving the related parameter accept response.

7. The apparatus as claimed in claim 6, wherein the apparatus is configured to:
receive, from the at least one other RAN function application, a related parameter reject response indicating that the change in the related parameter is rejected; and
reject the change in the one or more parameters upon receiving the related parameter reject response.

8. The apparatus as claimed in claim 1, wherein to trigger the one or more reconciliation actions, the apparatus is configured to:
determine, based on the set of mitigation rules, that an acceptance of the change in the one or more parameters is disallowed; and
reject the change in the one or more parameters.

9. The apparatus as claimed in claim 1, wherein:
when the network controller is the near RT-RIC, the apparatus is included in the near-RT RIC at one of a framework level or an application level, and
the parameter dependency model defines dependencies among E2 parameters and O1 parameters.

10. The apparatus as claimed in claim 1, wherein:
when the network controller is the non RT-RIC, the apparatus is included in the non-RT RIC at one of a framework level or an application level, and
the parameter dependency model defines dependencies among one or more of O1 parameters, O2 parameters, and A1 parameters.

11. The apparatus as claimed in claim 1, wherein the parameter dependency model and the set of mitigation rules are encoded in a machine-readable data format, and wherein the parameter dependency model is configured to be one of:
automatically generated by one or more of plurality of RAN function applications based on a generative Artificial Intelligence (AI) model, or
generated and linked to the apparatus during network design by an operator.

12. The apparatus as claimed in claim 1, wherein the one or more reconciliation actions include one or more of stopping one or more of the plurality of RAN function applications, adjusting a configuration of one or more of the plurality of RAN function applications, and adjusting an operation of E2 nodes associated with the network controller.

13. A method comprising:
receiving a request from a RAN function application from among a plurality of RAN function applications associated with a network controlled in an Open-Radio Access Network (O-RAN), the request being indicative of a change in one or more parameters associated with the plurality of RAN function applications;
determining, based on a parameter dependency model, whether a conflict will occur as a result of the change in the one or more parameters, wherein the parameter dependency model defines dependencies among a plurality of parameters associated with the plurality of RAN function applications; and
triggering, based on a set of mitigation rules associated with the parameter dependency model, one or more reconciliation actions upon a determination that the conflict will occur as a result of the change in the one or more parameters.

14. The method as claimed in claim 13, wherein determining whether the conflict will occur comprises:
identifying, based on the received request from the RAN function application, the one or more parameters associated with the request;
determining whether the identified one or more parameters are present in the parameter dependency model;
identifying, based on the parameter dependency model, whether the identified one or more parameters has a dependency on one or more of Key Performance Indicators (KPIs), policy parameters, configuration parameters, and control parameters associated with at least one of the network controller and the plurality of RAN function applications running in the network controller; and
determining whether the conflict will occur based on the dependency of the one or more parameters on one or more of the KPIs, the policy parameters, the configuration parameters, and the control parameters.

15. The method as claimed in claim 13, further comprising:
accepting the change in the one or more parameters upon a determination that the conflict will not occur as a result of the change in the one or more parameters.

16. The method as claimed in claim 13, wherein triggering the one or more reconciliation actions comprises:
determining, based on the set of mitigation rules, that an acceptance of the change in the one or more parameters is allowed;
determining a requirement of a change in a related parameter associated with at least one other RAN function application from among the plurality of RAN function applications;
sending, to the at least one other RAN function application, a related parameter request indicative of a request to accept the change in the related parameter;
receiving, from the at least one other RAN function application, a related parameter accept response indicating that the change in the related parameter is accepted; and
accepting the change in the one or more parameters in response to receiving the related parameter accept response.

17. The method as claimed in claim 16, comprising:
receiving, from the at least one other RAN function application, a related parameter reject response indicating that the change in the related parameter is rejected; and
rejecting the change in the one or more parameters upon receiving the related parameter reject response.

18. The method as claimed in claim 13, wherein triggering the one or more reconciliation actions comprises:
determining, based on the set of mitigation rules, that an acceptance of the change in the one or more parameters is disallowed; and
rejecting the change in the one or more parameters.

19. The method as claimed in claim 13, wherein the one or more reconciliation actions include one or more of stopping one or more of the plurality of RAN function applications, adjusting a configuration of one or more of the plurality of RAN function applications, and adjusting an operation of E2 nodes associated with the network controller.

20. The method as claimed in claim 13, wherein:
the policy parameters, the configuration parameters, and the control parameters are exposed as parameters through one or more open interfaces, the one or more open interfaces including one or more of A1 interface, O1 interface, and E2 interface,
the network controller is one of a Near-Real Time Radio Access Network Intelligent Controller (near RT-RIC) or a Non-Real Time Radio Access Network Intelligent Controller (non RT-RIC),
the plurality of RAN function applications includes one of xApps and rApps,
the parameter dependency model and the set of mitigation rules are encoded in a machine-readable data format, and
the parameter dependency model is configured to be one of automatically generated by one or more of plurality of RAN function applications based on a generative Artificial Intelligence (AI) model or generated during network design by an operator.
